(19) United States
(12) Patent Application Publication
(10) Pub. No.: US 2023/0236292 A1
(43) Pub. Date: Jul. 27, 2023

(54) APPARATUSES AND METHODS INVOLVING ADAPTIVE SCANNING FOR AN OPTIMIZED REGION OF INTEREST

(71) Applicant: The Board of Trustees of the Leland Stanford Junior University, Stanford, CA (US)

(72) Inventors: Zhanghao Sun, Mountain View, CA (US); Ronald Quan, Cupertino, CA (US); Olav Solgaard, Stanford, CA (US); Sandra Manosalvas-Kjono, Stanford, CA (US)

(21) Appl. No.: 18/101,036

(22) Filed: Jan. 24, 2023

Related U.S. Application Data
(60) Provisional application No. 63/303,586, filed on Jan. 27, 2022.

(51) Int. Cl. G01S 7/481; G01D 5/24

(52) U.S. Cl. CPC G01S 7/4817; G01D 5/24

(57) ABSTRACT

Certain examples are directed to circuitry and methods involving adaptive scanning of a target area, by use of a scanning output controlled by a multiple-axis scanner, within a selected region of interest (RoI) in a field of view (FoV) as a function of a first drive signal having a first set of one or more frequency components and of a second drive signal having a second set of one or more frequency components. One or more aspects of at least the first drive signal is modulated to produce a plurality of drive signals including the modulated first drive signal, and the drive signals at the multiple-axis scanner are used to: control the scanning output, cause the scanning output to traverse the selected RoI more times than other portions of the FoV and spatially sample the target area via a higher concentrations of samples in the RoI.

### BACKGROUND

Aspects of various embodiments are directed to apparatuses, systems, methods of use, and/or methods of manufacture, as described in the description, claims, and/or figures herein, all of which form part of this patent document.

As one of many example areas to which aspect of the present disclosure may be applied, certain aspects of the present disclosure may involve, but are not necessarily limited to, the field of fast-spatial light-based devices and scanners. Such devices and scanners may include, for example, radar-type scanners and using light beams or pulsed light technologies (e.g., light detection and ranging or “LiDAR” time-of-flight distance sensing), wherein signals are generated and used by a spatial scanner for sensing objects within the scanner’s field of view.

As applied to such example applications, in recent years there has been the rapid development of fast-spatial scanners in robotics, autonomous vehicles and other applications benefiting from fast-spatial scanning. Designing accurate and efficient scanning systems has been challenging in terms of both hardware (i.e., circuitry) and software since real-time response requires very fast information collection and processing. For ease of discussion, LiDAR is used as one such technology type which involves optical scanning to send (e.g., deflect) one or more laser beams onto different sampling positions in space and from which 3D data is to be acquired for analysis of any objects which may be in that scanned space.

A more specific example is a LiDAR scanner which uses a resonant-type scanner that employs Lissajous scanning. Such a resonant-type scanner is typically characterized in an opto-mechanical system involving use of two distinct scanning axes to provide a well-known advantage: when actuated at resonant frequency, the motion amplitude of a resonant scanner is ~ Q times larger than that of a raster scanner, where Q is the quality factor of the resonant scanner. Also, the resonant scanner’s speed is greatly improved (e.g., much higher than that of a raster scanner which acquires data in a prescribed sequential pattern that is limited by the speed of its slow axis).

Many real-world applications demand ever-increasing speeds of spatial sampling and accuracy in terms of ability to provide a realistic assessment of objects in selected fields of view.

### SUMMARY OF VARIOUS ASPECTS AND EXAMPLES

Various aspects and examples according to the present disclosure are directed to issues such as those addressed above and/or others which may become apparent from the following disclosure and it will be appreciated that according to various examples of the present disclosure, aspects and/or examples disclosed herein may be implemented separately or in any of various combinations.

In connection with certain example embodiments and example aspects, the present disclosure is directed to one or more aspects of an apparatus (e.g., system, device, circuitry, etc.) involving one or more aspects in one or a combination of the parts of this Provisional Application and including the provisional claims.

In certain specific types of examples, the present disclosure is directed to an apparatus (e.g., system, arrangement of structures, etc.) to provide an optimal scanning pattern within a region of interest. The apparatus includes a multi-dimensional scanner, and signal processing circuitry. The multi-dimensional scanner includes a first terminal associated with scanning along a first axis and a second terminal associated with scanning along a second axis. The signal processing circuitry, which may be integrated or coupled to the multi-dimensional scanner, is configured to: combine a first drive signal and a second drive signal and, in response, to provide a first combined signal that is coupled to the first terminal of the multi-dimensional scanner; and couple a third drive signal to the second terminal of the scanning device. The first combined signal may provide for an optimal scanning pattern within a region of interest (RoI).

In yet another type of example embodiment, the present disclosure is directed a method and/or apparatus involving a multiple-axis scanner that is from among multiple cooperatively-configured laser-scanners. The multiple laser-scanners are cooperatively configured and used to adaptively scan the RoI according to an optimized scanning trajectory which is divided into multiple sections, and wherein each scanner is actuated individually and follows one trajectory section.

In certain other examples which may also build on the above-discussed aspects, methods and semiconductor structures are directed to a method including steps of adaptive scanning, modulating and controlling (or using the drive signal(s) to control. More specifically, the target area is adaptively scanned by use of a scanning output from and/or controlled by a multiple-axis scanner, covering or within a selected RoI, wherein the RoI is in a certain field of view (FoV) and is a function of a first drive signal having a first set of one or more frequency components and of a second drive signal having a second set of one or more frequency components. The step of modulating involves modulating one or more aspects of at least the first drive signal to produce a plurality of drive signals including the modulated first drive signal. The drive signals are then used at or by the multiple-axis scanner to control the scanning output, to cause the scanning output to traverse the selected RoI more times than other portions of the FoV and thereby spatially sample the target area via a higher concentration of samples in the RoI.

Further, in a type of example where the sampling involves capacitive sensing (e.g., for measuring capacitance), a capacitance-type sensing system is implemented with the scanning output being directed by a MEMS mirror device capable of moving in two or more directions.

The above discussion is not intended to describe each aspect, embodiment or every implementation of the present disclosure. The figures and detailed description that follow also exemplify various embodiments.

### BRIEF DESCRIPTION OF FIGURES

Various example embodiments, including experimental examples, may be more completely understood in consideration of the following detailed description in connection with the accompanying drawings, each in accordance with the present disclosure, in which:

FIG. 1 shows an example embodiment of adaptive Lissajous scanning pattern optimization pipeline, and corresponding scanner actuation and control systems.

FIG. 2 shows an example embodiment of the region of interest (RoI) circuit-based pipeline.

FIG. 3A shows an example embodiment of LiDAR system with adaptive Lissajous pattern.

FIG. 3B shows another example embodiment of LiDAR system with adaptive Lissajous pattern.

FIG. 3C shows an example embodiment of an online adaptive Lissajous pattern optimization pipeline, integrated with a LiDAR system.

FIG. 3D shows another example embodiment of LiDAR system with adaptive Lissajous pattern.

FIG. 3E shows an example embodiment for multiple-scanner configuration.

FIG. 3F shows another example embodiment of LiDAR system with adaptive Lissajous pattern.

FIG. 4 shows an example embodiment of the present disclosure.

FIG. 5 shows another example embodiment of the present disclosure.

FIG. 6 shows yet another example embodiment of the present disclosure.

FIG. 7 shows examples for providing position to signal conversion (e.g., via a position sensing detector and a capacitance measurement system).

FIG. 8A shows an example of a capacitance measurement system.

FIG. 8B shows another example of a capacitance measurement system.

FIG. 8C shows another example of a capacitance measurement system.

FIG. 8D shows another example of a capacitance measurement system.

FIG. 9 shows yet another example of a capacitance measurement system.

FIG. 10 shows examples of implementing substantially 0 and 90 degree phase shifting.

FIG. 11 shows other examples of implementing substantially 0 and 90 degree phase shifting.

FIG. 12 shows examples of signal generators according to the present disclosure.

FIG. 13 shows another example of a signal generator according to the present disclosure.

FIG. 14 shows another embodiment according to the present disclosure.

FIG. 15 shows another embodiment according to the present disclosure.

FIG. 16 shows another embodiment according to the present disclosure.

FIG. 17 shows yet another embodiment according to the present disclosure.

While various embodiments discussed herein are amenable to modifications and alternative forms, aspects thereof have been shown by way of example in the drawings and will be described in detail. It should be understood, however, that the intention is not to limit the disclosure to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

Aspects of the present disclosure are believed to be applicable to a variety of different types of apparatuses, systems and methods involving devices characterized at least in part by adaptively scanning a region of interest such as in connection with exemplary applications involving a capacitive sensing/measurement system or an optical scanner (e.g., such as LiDAR). While the present disclosure is not necessarily limited to such aspects, an understanding of specific examples in the following description may be understood from discussion in such specific contexts.

Accordingly, in the following description various specific details are set forth to describe specific examples presented herein. It should be apparent to one skilled in the art, however, that one or more other examples and/or variations of these examples may be practiced without all the specific details given below. In other instances, well known features have not been described in detail so as not to obscure the description of the examples herein. For ease of illustration, the same connotation and/or reference numerals may be used in different diagrams to refer to the same elements or additional instances of the same element. Also, although aspects and features may in some cases be described in individual figures, it will be appreciated that features from one figure or embodiment can be combined with features of another figure or embodiment even though the combination is not explicitly shown or explicitly described as a combination.

Exemplary aspects of the present disclosure are directed to an example method involving a scanning output controlled by a multiple-axis scanner. The example method includes adaptively scanning a target area, via the scanning output, within a selected region of interest (RoI) in a field of view (FoV) as a function of a first drive signal having a first set of one or more frequency components and of a second drive signal having a second set of one or more frequency components. One or more aspects of at least the first drive signal are modulated to produce a plurality of drive signals including the modulated first drive signal, and then using the plurality of drive signals at the multiple-axis scanner to control the scanning output, the scanning output causes the selected RoI to be traversed more times than other portions of the FoV, thereby spatially sampling the target area via a higher concentrations of samples in the RoI.

In certain examples including methods and circuit-based apparatuses, the present disclosure is directed to scanning in a FoV by using a pattern that improves sensing in a RoI within the FoV. In one specific example, a signal having frequency components and a scan-pattern design are used, with an improved, balanced or even optimized set of attributes (e.g., optimized for a given scan application) with the set of attributes including a sampling-density and/or fill factor attribute, to scan (e.g., for providing focus for) a RoI in a FoV by the design pattern being more particular to the RoI (more than other regions in the FoV); for example, a design pattern may be selected or provided as being more particular to the RoI by sampling or traversing the RoI (more times than other regions in the FoV). In some instances, the sampling density attribute for a particular RoI in the FoV may be appreciated, for example, relative to characterizing by way of a fill factor which may be used in certain contexts to associate with sampled points distributed throughout the entire FoV (or in some cases throughout an entire square or rectangular area).

Consistent with the above aspects, such a manufactured device or method of such manufacture may involve aspects presented and claimed in U.S. Provisional Application Serial No. 63/303,586 filed on Jan. 27, 2022 (STFD.440P1 S20-531), to which priority is claimed. To the extent permitted, such subject matter is incorporated by reference in its entirety generally and to the extent that further aspects and examples (such as experimental and/more-detailed embodiments) may be useful to supplement and/or clarify.

In one specific example, the present disclosure is directed a method and/or apparatus involving a multiple-axis scanner that is configured to scan in at least two dimensions such as may be characterized by two or three axes (e.g., X and Y, X, Y and Z). The multiple-axis scanner may be used by: adaptively scanning a target area, by use of a scanning output controlled by a multiple-axis scanner, within a selected RoI in a field of view (FoV) as a function of a first drive signal having a first set of one or more frequency components and of a second drive signal having a second set of one or more frequency components; modulating one or more aspects of at least the first drive signal to produce a plurality of drive signals including the modulated first drive signal; and using the plurality of drive signals at the multiple-axis scanner to control the scanning output, to cause the scanning output to traverse the selected RoI more times than other portions of the FoV and spatially sample the target area via a higher concentrations of samples in the RoI. The selected RoI may be generated, for example, as data for one of multiple regions in the FoV, wherein the generated data corresponding to the selected RoI corresponds to one or more prioritized or more heavily weighted ones of the multiple regions in the FoV.

In specific examples, the modulating may involve altering one or more aspects of at least the first drive signal (e.g., alone or similarly with the second drive signal) in terms of one or more of: frequency, amplitude and phase, and at least the first drive signal includes or corresponds to a set of multi-frequency signals and the modulating may involve changing one or more of its frequency (or frequencies), amplitude (or amplitudes) and phase (or phases). In more specific examples, this may involve maintaining a tone set by its frequencies and variation at least one of the amplitude and phase of the first drive signal and in some cases of the amplitudes and phases of the first drive signal and of the second drive signal.

In more specific aspects also according to the present disclosure, such a multiple-axis scanner is driven to follow an optimized scanning trajectory, which is set as a function of the optimization pipeline, and to produce a corresponding sampling pattern. Further, the method may include generating for the scanning a set of RoI-estimation data as a function of depth and intensity information uniformly detected across the FoV, wherein the selected RoI is processed as a function of the set of RoI-estimation data.

In certain other specific examples and aspects also according to the present disclosure, the multiple-axis scanner is to produce a scanning output that is specific to a display, type of sensing and/or scanning technology such as involving capacitance-type sensing. For example, the scanning output may be one of a light beam, a piezo-electrical signal, and a magnetic signal.

In connection with such specific examples involving capacitance-type sensing, the method and/or apparatus may include using a capacitance-type sensing system, wherein the scanning output is directed by a MEMS mirror device capable of moving in two or more directions. For example, a capacitance-type sensing system may be configured to generate a first axis output signal and a second axis output signal according to a scanning pattern in the RoI, with the RoI being characterized as a function of a first axis and a second axis, wherein the capacitance-type sensing system scans the RoI using a scanning motion, via a first high frequency signal related to the first axis and using a second frequency signal related to the second axis.

In another type of example embodiment, the present disclosure is directed a method and/or apparatus involving a multiple-axis scanner that is from among multiple cooperatively-configured laser-scanners. The multiple laser-scanners are cooperatively configured and used to adaptively scan the RoI according to an optimized scanning trajectory which is divided into multiple sections, and wherein each scanner is actuated individually and follows one trajectory section.

In related and more-specific examples, the present disclosure is directed to scan-signal control circuitry (e.g., a MEMs-type controller) and processing circuitry which is configured (e.g., programmed) to find the scan-pattern design based on different parameters involving aspects such as at least one of amplitude, phase, and a number of different frequency components used in connection with the scanning signal and/or scan pattern design.

In one specific example that builds on one or more of the above examples, the present disclosure is directed to an apparatus, such as a circuit-based device, and a method for using the apparatus, involving signal processing circuitry which may be used to scan in a FoV by using a pattern that improves sensing in a RoI within the FoV. The signal, which may have multiple frequency components, can be used with a particular scan-pattern design and with a balanced or optimized set of attributes including a sampling density attribute, may be used to scan a RoI in a FoV by sampling or traversing the RoI more times than other regions in the FoV. In related more-specific examples, such scanning circuitry finds the scan-pattern design based on an algorithm that processes different parameters involving at least one of amplitude and phase and processes a number of different frequency components related to or including the multiple frequency components, wherein the number of different frequency components is from a minimum of two or three up to a threshold limit (e.g., from five to a number less than ten) where this threshold limit is deemed as at point at which processing an increased number of different frequency components for the specific application or implementation provides negligible improvement.

In certain other examples which may also build on the above examples and/or aspects, methods and apparatus are directed to one or more of the following: the resonant frequencies being within a predetermined or resonance bandwidth of the scanning frequencies in the signal; finding the scan-pattern design based on a task-driven algorithm that varies scan-patterns variables according to different possible scan regions in the FoV; and finding the scan-pattern design as being optimal for the RoI, and in response, providing concentrated spatial sampling or traversing for the RoI.

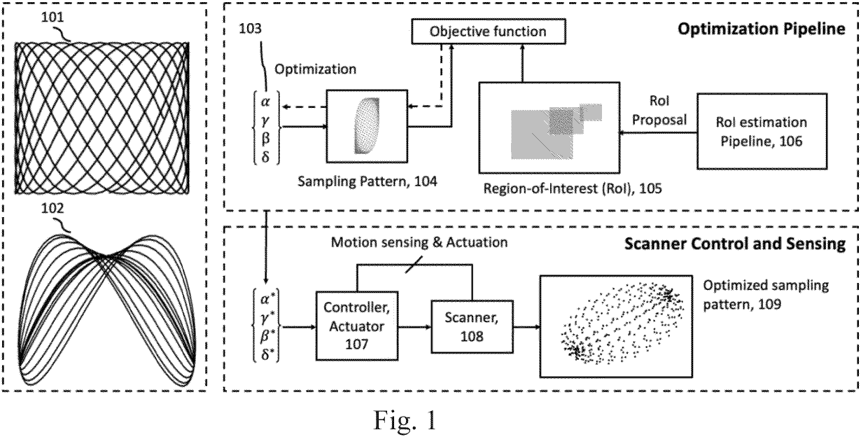

Optical scanners deflect laser beams into different spatial locations over time, and hereafter, either sample sensing information from these spatial locations or distribute display content onto these spatial locations. Most optical scanners can be simplified as linear systems. When a sinusoidal actuation signal is used as input, the scanner motion is also sinusoidal, with the same frequency as the actuation signal. The amplitude of scanner motion is determined by the actuation amplitude and the system transfer function. Conventionally, Lissajous pattern scanning is implemented with a 2-axis optical scanner, each axis actuated at a single frequency close to the resonant frequency ƒₓᵣ (or ƒ_{yr}). In the following, we refer to such scanning patterns as “unmodulated” or “non-adaptive”. The x and y scanner motion trajectories are expressed in Eq. (1). FIG. 1 shows an example of such scanning pattern (101) on the upper left.

$$\begin{matrix}x \left(t\right) = {H}_{x} \left({f}_{x}\right) {A}_{x} c o s \left({f}_{x} t + {ϕ}_{x}\right) \\ y \left(t\right) = {H}_{y} \left({f}_{y}\right) {A}_{y} c o s \left({f}_{y} t + {ϕ}_{y}\right)\end{matrix}$$

In Eq. (1), Hₓ and H_{y} are amplitude transfer functions in x and y scanning axes. Aₓ and A_{y} are actuation signal amplitudes. ƒₓ and ƒ_{y} are actuation signal frequencies and ϕₓ and ϕ_{y} are phases.

In the following, we use “scanning pattern” and “scanning trajectory” interchangeably, both refer to the trajectory of continuous motion of the optical scanner or laser beam deflected by the scanner. We refer to the “sampling pattern” as the temporally discretized scanning pattern. This temporal discretization comes from the bandwidth of either light source modulation or sensor response.

The present disclosure may extend the conventional, non-adaptive Lissajous patterns to adaptive Lissajous patterns. One or more embodiments of the automatic design pipeline for the adaptive Lissajous patterns are described in detail. One or more embodiments integrating the present disclosure with sensing or display systems are described in detail. When the actuation signal contains multiple frequency components, the scanner motion also contains the same set of frequency components, as expressed in Eq. (2). In the following, we refer to such scanning patterns as “modulated” or “adaptive”. FIG. 1 shows an example of such scanning pattern (102) on the lower left.

$$\begin{matrix}x \left(t\right) = {\sum }_{n = n 1}^{n 2} {α}_{n} {H}_{x} \left({f}_{x n}\right) c o s \left({f}_{x n} t\right) + {γ}_{n} {H}_{x} \left({f}_{x n}\right) s i n \left({f}_{x n} t\right) \\ y \left(t\right) = {\sum }_{s = s 1}^{s 2} {β}_{s} {H}_{y} \left({f}_{y s}\right) c o s \left({f}_{y s} t\right) + {δ}_{s} {H}_{y} \left({f}_{y s}\right) s i n \left({f}_{y s} t\right)\end{matrix}$$

In Eq. (2), Hₓ and H_{y} are transfer function amplitudes, and the set n1, n2, s1, s2 defines the number of frequency components in optimization compatible with the actuation system. The scanner motion is linearly determined by the parameter set {αₙ}, {βₛ}, {γₙ}, {δₛ}. Also, due to the band-pass characteristics of the transfer functions Hₓ and H_{y}, only frequency components close enough to the resonant frequencies ƒₓᵣ, ƒ_{yr} have a significant impact on scanner motion. Therefore, the amount of frequency components does not need to be large. Empirically, three to five frequency components are enough for each scanning axis to achieve flexible, adaptive scanning patterns.

In Eq. (2), Hₓ and H_{y} (and implicitly ƒₓᵣ, ƒ_{yr}) are defined by the scanner hardware. Actuation frequencies set {ƒₓₙ}, {ƒ_{ys}} are manually selected and fixed. {αₙ}_{,} {βₛ}, {γₙ}, {δₛ} are used as actuation signal amplitudes and may be set to arbitrary values within the capacity of actuator hardware.

Compared with conventional non-adaptive Lissajous scanning, where laser beam trajectories are uniform across the field of view (FoV), adaptive Lissajous scanning offers flexible focus onto at least one specified RoI (e.g., the deflected laser beam traverses the RoI more times than other portions of the at least one FoV). The parameter set {αₙ}, {βₛ}, {γₙ}, {δₛ} are designed (or, automatically optimized) for this purpose.

Upper right part of FIG. 1 shows an example embodiment of automatic adaptive Lissajous pattern optimization pipeline. The pipeline is task-driven because different applications have different sets of one or more RoIs. In the pipeline, the parameter set {αₙ}_{,} {βₛ}, {γₙ}, {δₛ} (103) is first converted into a sampling pattern (X, Y) (104), with hardware specified temporal discretization. Regions-of-Interest (RoI) (105) may be proposed by a RoI estimation pipeline (106). The RoI is represented by a weight map W and its values correspond to the importance of each region in the FoV. With X, Y and W, the optimization objective function Lₚₐₜₜₑᵣₙ is defined in Eq. (3).

$${L}_{p a t t e r n} = {\sum }_{i , j}^{M} {\overline{W}}_{i j} \left[{\left(x {c}_{i j} - X \left[{n}_{i j}\right]\right)}^{2} + {\left(y {c}_{i j} - Y \left[{n}_{i j}\right]\right)}^{2}\right]$$

In Eq. (3), the normalized field-of-view (FoV) is divided into M × M patches. For each patch (i,j), (X[nᵢⱼ ], Y[nᵢⱼ ]) denotes the closest sampling point to its center location (xcᵢⱼ, ycᵢⱼ). W indicates the importance of each patch and is defined as the average of the weight map W in patch (i,j). Patches with larger average weights have a higher priority during optimization. With Lₚₐₜₜₑᵣₙ, gradient descent optimization is performed on the parameter set {αₙ}, {βₛ}, {γₙ}, {δₛ}.

Lower right part of FIG. 1 shows an example embodiment of scanner actuation and control system compatible with the multi-frequency, adaptive Lissajous scanning. After the optimization converges, the optimized parameter set {α*}, {β*}, {γ*}, {δ*} are used to set the wide-band actuator (107) states. The scanner (108) is driven to follow the optimized scanning trajectory and produce the corresponding sampling pattern (109). Feedback control of the scanner is achieved with a wide-band motion/position detection device and a processor.

The adaptive Lissajous pattern may be used for either sensing or display purposes. In both cases, the spatial sampling is more concentrated in the RoI, where most useful information is distributed, and the performance of down-stream tasks is improved. This optimization process may be either online (during scanner operation) or offline (conducted beforehand and fixed thereafter). It can also be either synchronized or unsynchronized with the frames of the higher-level sensing/display systems. In the synchronized case, the pattern is optimized for each frame. In the unsynchronized case, the same pattern is used for multiple frame times, due to almost unchanged RoI in several successive frames.

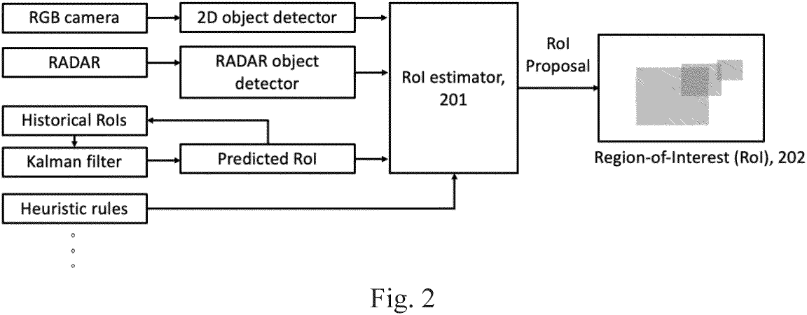

FIG. 2 shows an example embodiment of a system such as disclosed above and also according to the present disclosure, with a RoI pipeline. The pipeline may rely on higher-level heuristic rules, processing on sensing results from other sensors (e.g., RGB cameras, RADAR sensors), or previous sensing results of the same sensor. A Kalman filter type algorithm predicts the current RoI based on the previously- estimated RoIs and their displacements over time, with confidence values. All information is proposed by either a heuristic weighted average or a lightweight neural network architecture (201), to regress the final RoI proposal (202).

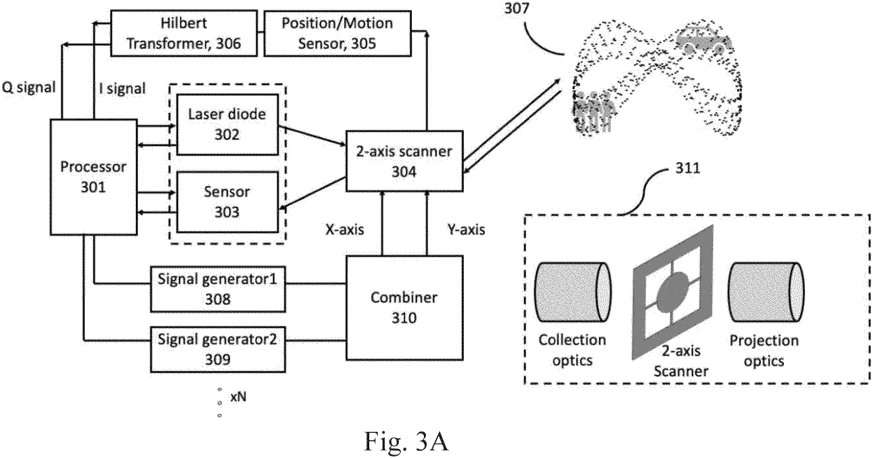

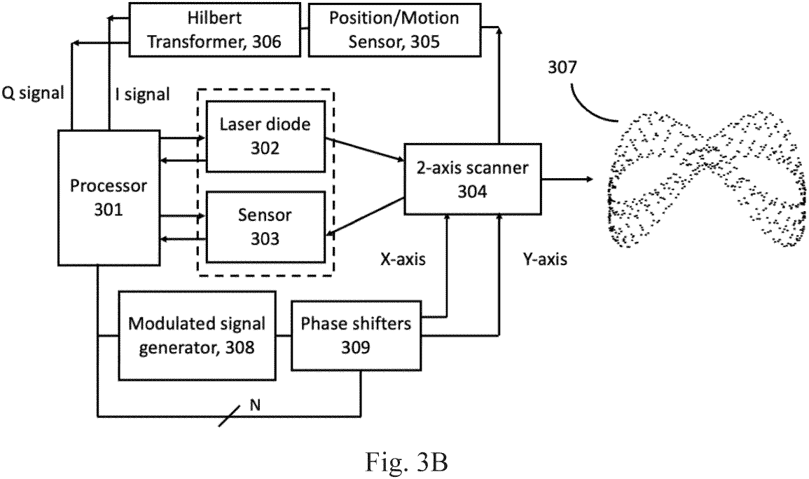

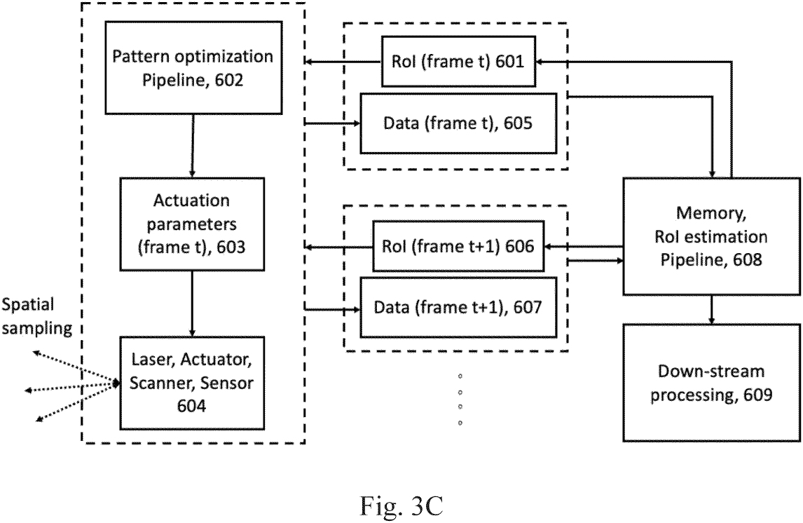

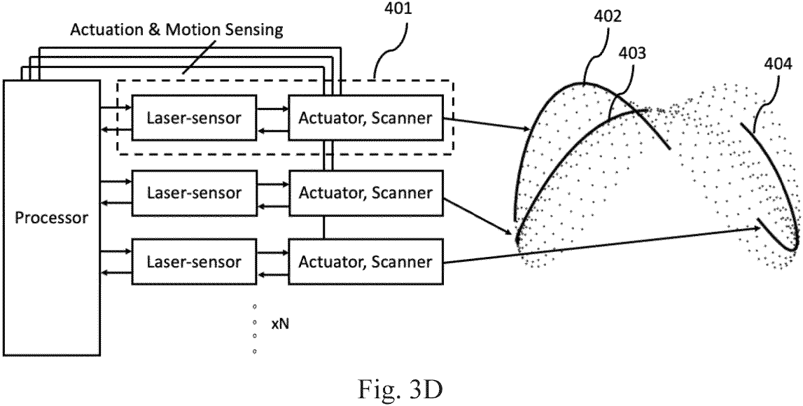

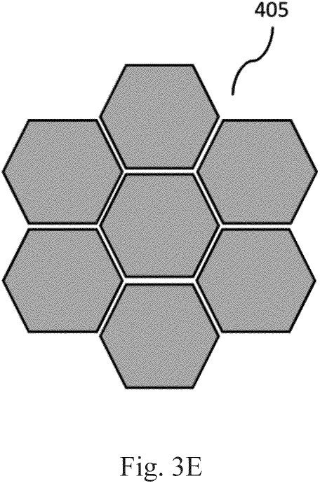

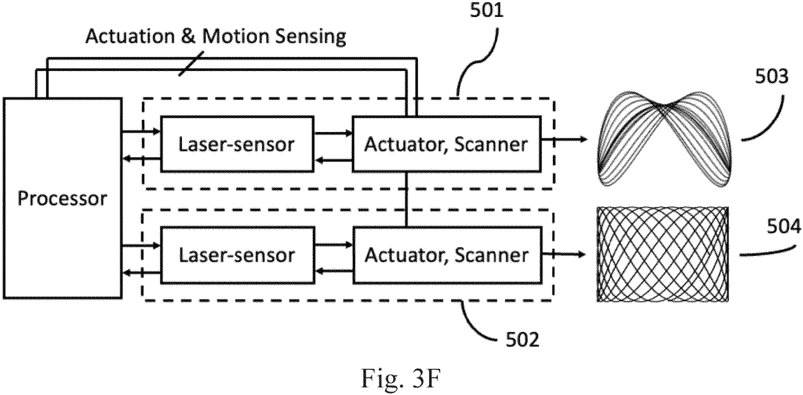

FIG. 3A shows an example embodiment of a Light Detection and Ranging (LiDAR) system with adaptive Lissajous pattern (307). The pattern focuses on specific targets, including pedestrians, cars. In a LiDAR system, Processor (301) controls a laser emitter module (302), a photon sensor module (303) and multiple (N) signal generators (308, 309). Each signal generator provides one frequency component for the scanner and their frequencies/phases/amplitudes are controlled by the processor. The actuation signals from the signal generators are combined by a combiner (310) and sent into the two scanning axes of the scanner (304). An alternative embodiment of the system may also contain projection optics and collection optics on the two sides of the scanner, forming an optical 10 module (311). The motion/position sensor (305) may be optical, capacitive, piezo-electrical or magnetic. Its output may be converted into an in-phase signal (I-signal) and a quadrature signal (Q-signal) with a wide-band electronic Hilbert transformer (306), which simplifies the processor phase computation. This motion/position sensing - actuator control feedback control may be conducted continuously or at discrete time steps. The processor receives and processes photon detection data from the sensor, photon emission data from the laser module, and motion sensing data from the scanner. A reconstruction of 3D geometry (point cloud) is performed and provides necessary information for down-stream computations, including, but not restricted to, object detection, object tracking and action decisions.

FIG. 3B shows an alternative embodiment of LiDAR system with adaptive Lissajous pattern. The signal generator bank in FIG. 3A is replaced by an amplitude modulated signal generator (308) and a phase shifter bank (309). The phase shifter bank is controlled by the processor. Each phase shifter shifts the phase of one frequency component of the amplitude modulated signal.

FIG. 3C shows an example embodiment of the online optimization pipeline (602, 603, 604) integrated with a LiDAR system. To save computation time, at each frame, the optimization does not start from scratch. Instead, the parameters are initialized as the optimization results in the last frame (601, 605). Empirically, the number of iterations required for optimization convergence reduces from 20 to 5 through this better initialization strategy, and/or the optimization is conducted up to 50 Hz.

Apart from estimating the RoI based on other sensors’ data, the RoI may also be estimated with trajectory predictions to achieve faster scanning pattern adjusting capability (608). A Kalman-filter type algorithm is used to predict displacement of each object being tracked and the RoI is adjusted accordingly. The same optimization process is applied once the RoI changes.

FIG. 3D shows an alternative embodiment of LiDAR system with adaptive Lissajous pattern. The LiDAR system consists of multiple laser-scanner-sensor (401) subsystems. The optimized scanning trajectory is divided into multiple sections (402, 403, 404). Each scanner is actuated individually and follows one trajectory section. In this way, the scanning is conducted in parallel and further speeds up the spatial information acquisition or distribution process.

FIG. 3E shows an example embodiment that contains multiple scanners (scanning mirrors), with compact form-factor due to the dense packing property. Such scanner array (or similar ones) may be applied in multi-scanner system (e.g. in FIG. 3D).

FIG. 3F shows an alternative embodiment of LiDAR system with adaptive Lissajous pattern. The LiDAR system consists of two laser-scanner-sensor (501, 502) subsystems. One of the laser-scanner-sensor sub-system conducts spatial sampling following a conventional Lissajous sampling pattern (504). Depth and intensity information is uniformly detected across the field of view (FoV). This sub-system provides rough estimation of RoI to be used in pattern optimization, including important objects, potential dangers. The other sub-system follows an adaptive Lissajous pattern (503) and acquires denser, more detailed information in the RoI specified by the first sub-system (502).

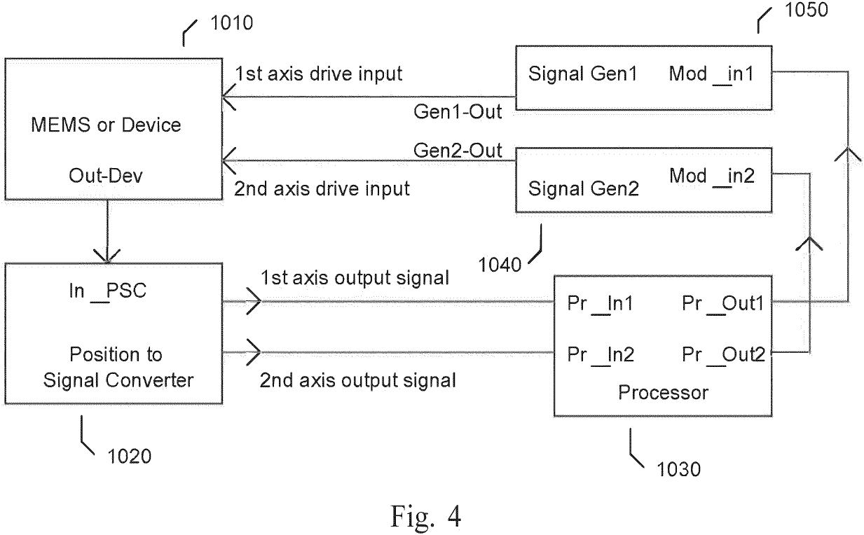

Turning now to more specific and detailed descriptions on hardware components and apparatus. An apparatus/method to provide one or more modulated signals to a MEMS device (or electromechanical device) is shown in FIG. 4. The MEMS device or electromechanical device is depicted by block 1010, which includes a 1^{st} axis drive input terminal and/or a 2^{nd} axis drive input terminal. For example a 1^{st} axis may include an X axis, and/or a 2^{nd} axis may include a Y axis, or vice versa.

In FIG. 4, MEMS (or Device) 1010 couples an output signal, OUT-Dev to a Position to Signal Converter 1020. MEMS (or Device) 1010 may provide deflection along one or more axis via electrostatic force(s) and/or via electromagnetic force(s).

A Position to Signal Converter may be implemented by an optical beam shining into an imaging device. A light signal or beam provides a scanning pattern may be included in OUT-Dev. For example, 1010 may include a moving mirror whereby a light source is shined into the mirror to provide a portion of reflected light (e.g., which traces out a scanning pattern). The portion of reflected light is coupled to the Position to Signal Converter (1020), wherein 1020 may include a Position Sensing Detector (e.g., PSD), an imaging device, an image array, or a camera. One or more output terminals of Position to Signal Converter 1020 provide(s) a 1^{st} axis output signal and/or a 2^{nd} axis output signal.

Alternatively the MEMS (or Device) 1010 may include an electrostatic device. Such an electrostatic device may include a terminal that provides for measuring capacitance or changes in capacitance in one or more axis (e.g., of the electrostatic device 1010 or of device 1010 or of MEMS device 1010).

A Position to Signal Converter may be implemented by a capacitance measuring system, which measures capacitance or capacitance changes from the device 1010.

An example of a capacitance measuring system may include: For one example, not shown in FIG. 4, a first high frequency signal is coupled the 1^{st} axis drive input of 1010. For example, the output of Signal Gen1, 1050, is combined with the first high frequency signal to provide a first composite signal. The 1^{st} axis drive input of 1010 receives signals from Signal Gen1, 1050 and/or the first high frequency signal. Capacitance related to the 1^{st} axis of 1010 will provide a first high frequency signal current via the first high frequency signal. Similarly, a second high frequency signal is combined with the output signal from Signal Gen2, 1040, to form a second composite signal. The 2^{nd} axis drive input of 1010 receives signals from Signal Gen2, 1040, and the second high frequency signal. Capacitance related to the 2^{nd} axis of 1010 will provide a second high frequency signal current related to the second high frequency signal. The two currents, first high frequency current and second high frequency current, are coupled (e.g., via Out_Dev of 1010) to an input to a position to signal converter including capacitance measurement system (e.g., 1020 In_PSC). For example, OUT-Dev may include a signal current indicative of capacitance related to the 1^{st} axis and/or capacitance related to the 2^{nd} axis. The signal current indicative of capacitance related to the 1^{st} axis and/or capacitance related to the 2^{nd} axis is coupled to an input terminal to Position to Signal Converter 1020. Position to Signal Converter supplies a 1^{st} axis output signal and/or a 2^{nd} axis output signal, wherein the 1^{st} axis output signal is indicative of a 1^{st} axis position of device 1010 via a measured capacitance of device related to the 1^{st} axis and/or a 2^{nd} axis output signal that is indicative of a 2^{nd} axis position of device 1010 via a measured capacitance related to the 2^{nd} axis.

A Position to Signal Converter may include a filter or any combination of a band pass filter, band eject filter, low pass filter, high pass filter, amplifier, detector circuit/function, signal cancellation circuit/function, and/or demodulator.

A capacitance measurement system or circuit may include a filter or any combination of a band pass filter, band eject filter, low pass filter, high pass filter, amplifier, signal cancellation circuit/function, and/or demodulator.

In another example, electrostatic and/or magnetic force(s) may be utilized to provide movement or provide a determined position for one or more axis of device 1010.

In one embodiment, FIG. 4 shows an apparatus and/or method to provide one or more processed signals (e.g., Pr_Out1 and/or Pr_Out2) to one or more modulation input terminals (e.g., Mod_in1 and/or Mod_in2) of one or more signal generators (e.g., Signal Gen1, block 1050 and/or Signal Gen2, block 1040).

The one or more signal generators 1050 and/or 1040 may provide one or more modulated signals to a multiple axis device such as a MEMS device (1010). The multiple axis device provides scanning or movement in at least one of the axes, whereby information from a Position to Signal Converter provides one or more signal(s) pertaining to a scanning pattern via a 1^{st} axis output signal and/or a 2^{nd} axis output signal. For example, at least one modulated drive signal to 1010 may provide for an optimized scanning pattern or for a particular scanning pattern. A modulated signal may include any combination of amplitude modulation, phase modulation, and/or frequency modulation. A modulated signal may include a fixed (or dynamic or time varying) level of amplitude, a fixed (or dynamic or time varying) phase angle value, and/or fixed (or dynamic or time varying) frequency.

The one or more signal generators 1050 and/or 1040 may provide one or more predetermined or preprogrammed signals to a multiple axis device such as a MEMS device (1010). For example, signal generators 1050 and/or 1040 may provide one or more signals to set one or more phase, amplitude, and/or frequency of one or more signals coupled to the 1^{st} axis drive input and/or 2^{nd} axis drive input of 1010. For example, via one or more output signals (e.g., Pr_Out1 and/or Pr_Out2) from a processor (e.g., 1030) may provide for setting phase, amplitude, and/or frequency of signal generator 1050 and/or generator 1040 to provide for an optimal scanning pattern or to provide for a particular scanning pattern.

The multiple axis device (e.g., 1010) provides scanning or movement in at least one of the axes, whereby information from a Position to Signal Converter provides one or more signal(s) pertaining to a scanning pattern via a 1^{st} axis output signal and/or a 2^{nd} axis output signal.

Processor 1030 receives the 1^{st} axis output signal and/or 2^{nd} axis output signal to determine an optimized scanning pattern of the device 1010 by outputting one or more signals to change (or to modulate) the amplitude, phase, and/or frequency of Signal Gen1 (1050) and/or Signal Gen2 (1040).

For example, a multiple axis device may include X and Y axes (e.g., as found in a Cartesian plane). A MEMS device may scan in X and/or Y directions to provide a scanning pattern (e.g., for sensing or for displaying). As a function of time, the MEMS device may provide scanning pattern of X(t) and/or Y(t), wherein each value of time, t, represents a point in an X Y plane.

For example, a modulated signal may include a first signal (e.g., a first carrier signal or first driving signal), which is modulated in terms of amplitude, phase, and/or frequency modulation by a second signal (e.g., wherein the second signal includes a first modulating signal).

Another example of a modulated signal may include combining at least two signals.

A modulated signal may include combining a first signal with a second signal. A first signal may include a first amplitude, first frequency and/or first phase angle. A second signal may include a second amplitude, second frequency and/or second phase angle.

Alternatively a modulated signal may include combining N number of signals wherein N ≥ 2.

For example a combination of N signal may provide a modulated signal by summing/combining: a first signal including a first amplitude, first frequency and/or first phase angle; a second signal including a second amplitude, second frequency and/or second phase angle; and an Nth signal including an Nth amplitude, Nth frequency and/or Nth phase angle.

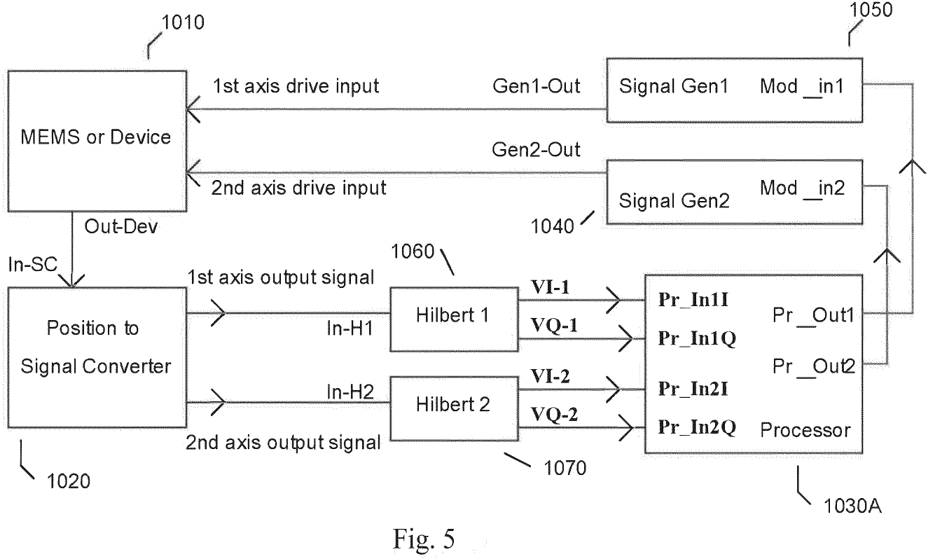

FIG. 5 shows an example of FIG. 4 wherein signals (e.g., 1^{st} axis output signal and/or 2^{nd} axis output signal) from the Position to Signal Converter (1020) are coupled to Hilbert Transform functions/circuits (e.g., blocks 1060 and/or 1070) to provide In Phase signals (e.g., an In Phase signal provides 0 degree phase angle denoted as an “I” signal); Quadrature Phase signals (e.g., a Quadrature Phase signal has a 90 degree phase shift relative to the In Phase; a Quadrature Phase signal is denoted as a “Q” signal).

In FIG. 5 the 1^{st} axis output signal is coupled to Hilbert 1, 1060, which provides a 0 degree signal VI-1, and a 90 degree phase shifted signal, VQ-1. Signals VI-1 and VQ-1 are coupled to inputs Pr_in1I and Pr_in1Q of processor 1030A.

In FIG. 5 the 2^{nd} axis output signal is coupled to Hilbert 2, 1070, which provides a 0 degree signal VI-2, and a 90 degree phase shifted signal, VQ-2. Signals VI-2 and VQ-2 are coupled to inputs Pr_in2I and Pr_in2Q of processor 1030A.

Hilbert Transform functions/circuits, Hilbert 1 and Hilbert 2, provide information to processor 1030A including providing for a phase angle calculation/determination for a drive signal of the 1^{st} axis (e.g., Gen1_out) and/or providing for a phase angle calculation/determination for a drive signal of the 2nd axis (e.g., Gen2_out).

With the Hilbert Transform circuits or functions (e.g., Hilbert 1 block 1060, Hilbert 2 block 1070) providing I and Q signals to processor 1030A, phase measurements can be determined on the 1^{st} axis output signal and/or the 2^{nd} axis output signal, which then for example the phase measurements can be processed via processor 1030A to output a first modulation signal to Signal Gen1, 1050 and/or to output a second modulation signal to Signal Gen2, 1040. In one embodiment, processor 1030A outputs a first modulation signal via Pr_Out1, which is coupled to modulation input, Mod_in1 of 1050, and/or processor 1030A output a second modulation signal via PR_Out2 to modulation input Mod_in2 of 1040.

For example, with phase angle calculations via Hilbert 1 and/or Hilbert 2, processor 1030A may provide one or more phase modulating signal and/or provide one or more amplitude modulating signal to generator(s) 1050 and/or 1040. Supplying (or providing) one or more phase modulation and/or amplitude modulating signals to a device (e.g., 1010) from generator(s) 1050 and/or 1040 provides for an optimal scanning pattern. An optimal scanning pattern may cover a specific portion of an area with increased resolution, wherein the resolution includes spatial resolution and/or temporal resolution.

For example, a driving signal to a device or MEMS device (e.g., 1010 in FIGS. 4, 5, and/or 6), which includes amplitude modulation and/or phase modulation provides for an optimal scanning pattern.

A driving signal to a device or MEMS device (e.g., 1010 in FIGS. 4, 5, and/or 6), which includes amplitude modulation and/or phase modulation provides for increased resolution, wherein the resolution includes spatial resolution and/or temporal resolution. Resolution includes spatial resolution and/or temporal resolution.

A driving signal to a device or MEMS device (e.g., 1010 in FIGS. 4, 5, and/or 6), which includes amplitude modulation and/or phase modulation provides for increased resolution in one or more localized areas. Resolution includes spatial resolution and/or temporal resolution.

A Hilbert Transform function or circuit such as Hilbert 1 or Hilbert 2 can provide phase angle information or calculation or measurement via an In Phase signal and a Quadrature Phase signal. For example, phase information or phase angle can be obtained or implemented via computation such as having a processor (e.g., utilizing Processor 1030 in FIG. 4, or Processor 1030A in FIG. 5) compute or measure via the using an arctangent function such as taking the arctangent of a ratio of Quadrature phase signal value to In phase signal value. For example:
Phase angle = tan⁻¹ (Quadrature Phase signal value/In Phase signal value)
Phase angle related to a 1^{st} axis =
tan⁻¹ (Quadrature Phase signal VQ-1 value via Hilbert 1/In Phase signal VI-1 value via Hilbert 1)

Similarly, phase angle related to a 2^{nd} axis =
tan⁻¹ (Quadrature Phase signal VQ-2 value via Hilbert 2/In Phase signal VI-2 value via Hilbert 2)

Optionally processor 1030 or 1030A may provide amplitude measurements via a Quadrature Phase signal and an In Phase signal. For example,

$$\text{Amplitude = A =} \sqrt{{\left⌊I \left(t\right)\right⌋}^{2} + {\left⌊Q \left(t\right)\right⌋}^{2}}$$

Another example may include the amplitude of the 1^{st} axis output signal, A₁ₛₜ_{_axis}, or the amplitude of the 2^{nd} axis output signal, A_{2nd}_{_axis}, that are characterized as:

$${\text{A}}_{\text{1st\_axis}} = \sqrt{{\left[\text{I} 1\right]}^{2} + {\left[Q 1\right]}^{2}}$$

$$\text{I1} = \text{VI-1} \text{and} \text{Q1} = \text{VQ-1}$$

$${\text{A}}_{\text{2nd\_axis}} = \sqrt{{\left[\text{I2}\right]}^{2} + {\left[Q 2\right]}^{2}}$$

$$\text{I2} = \text{VI-2} \text{and} \text{Q2} = \text{VQ-2}$$

Output signals from Processor 1030A, Pr_out1 and/or Pr_Out2 are coupled to the modulation input terminals of the signal generators 1050 and 1040 to provide/supply one or more modulated signal to MEMS or Device (e.g., 1010), which for example, provides for an optimal scan pattern or for a particular scan pattern.

A scan pattern may be a scanning pattern.

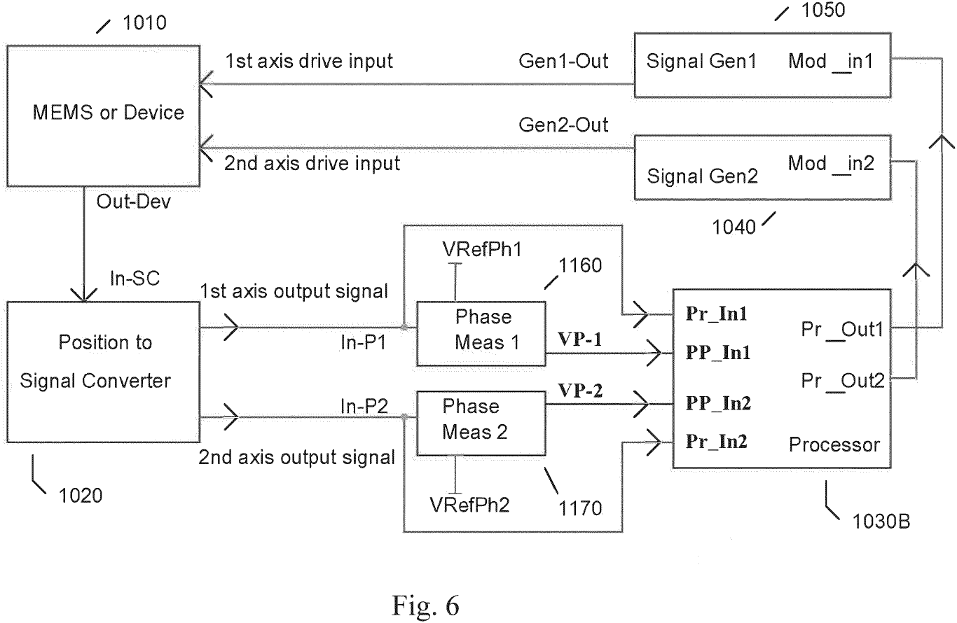

FIG. 6 shows an alternative embodiment. To provide phase information or to measure phase of the 1^{st} axis output signal and/or 2^{nd} axis output signal, this embodiment includes a phase measurement system 1160 (e.g., Phase Meas 1) and a phase measurement system 1170 (e.g., Phase Meas 2). Blocks 1160 and/or 1170 may include a phase detector, phase demodulator, multiplier, flip flop, and/or logic gate to provide measuring phase of the 1^{st} axis output signal and/or of the 2^{nd} axis output signal. For example, FIG. 6 via phase measurement blocks 1160 and 1170 shows an alternative to using In Phase and Quadrature Phase signals for providing phase measurements or calculations (e.g., FIG. 5 shows using In Phase and Quadrature signals for providing/calculating phase measurements).

Phase measurement system 1160 receives a first input signal via In-P1 from the 1^{st} axis output signal and a second input signal via a first reference phase signal VrefPh1. An output signal, VP-1, from 1160 is indicative of the phase of the 1^{st} axis output signal.

Similarly for measuring the phase of the 2^{nd} axis, Phase measurement system 1170 receives a first input signal via In-P2 from the 2^{nd} axis output signal and a second input signal via a second reference phase signal VrefPh2. An output signal, VP-2, from 1170 is indicative of the phase of the 2^{nd} axis output signal.

In one example, the phase of signal VrefPh1 may be substantially the same phase as signal VrefPh2; or the phase of signal VrefPh1 may be different from the phase of signal VrefPh2.

Processor 1030B receives phase information signals VP-1 and VP-2, along with 1^{st} axis output signal and 2^{nd} axis output signal into the input terminals of Processor 1030B via inputs PP_In1, PP_In2, Pr_In1, and Pr_in2 (e.g., respectively). Output signals from Processor 1030B, Pr_out1 and/or Pr_Out2 are coupled to the modulation input terminals of the signal generators 1050 and 1040 to provide/supply one or more modulated signal to MEMS or Device 1010, which provides for an optimal scan pattern.

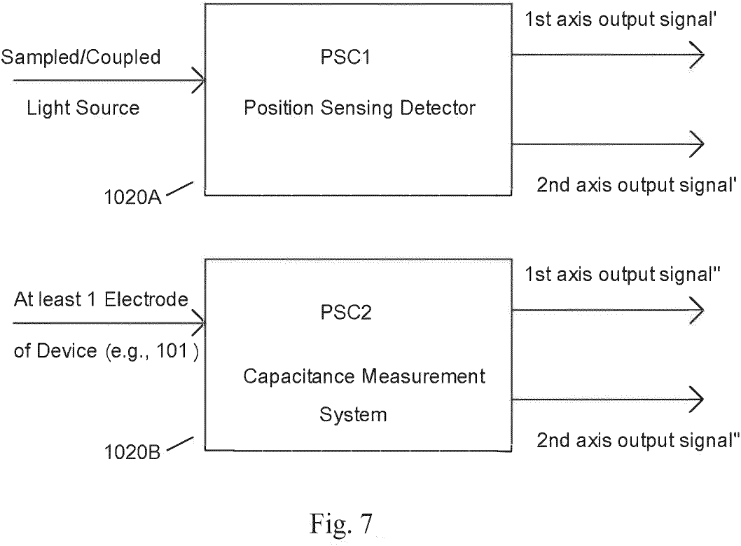

FIG. 7 shows an example of implementing a Position Signal Converter (PSC1), 1020A, whereby a scanning pattern can be displayed in terms of a multiple dimensional signal or in terms of two or more signals such as a first signal corresponding to movement or position on a first axis, and another signal (e.g., a second signal) corresponding to movement or position on a second axis. A light source is directed to a MEMS device (e.g., 1010) or a mirror device that is driven by signal generators (e.g., 1040 and 1050 in FIG. 4, FIG. 5, and/or FIG. 6). The MEMS or mirror device (e.g., 1010) reflects (or couples) a scanning pattern light beam into a Position Sensing Detector (e.g., a two dimensional Position Sensing Detector or also known as an X-Y or 2 dimensional PSD).

A Positional Sensing Detector or PSD provides signals (e.g., 1^{st} axis output signal′ and 2^{nd} axis output signal′) related to (e.g., the) two axes related to the scanning pattern.

Another embodiment (e.g., 1020B in FIG. 7) that provides signals related to scanning pattern for two or more axes or dimensions is a capacitance measuring system for an electrostatic device that includes a MEMS mirror device capable of moving in two or more directions (e.g., a MEMS device with electrodes controlling movement along two axes such as an X axis and a Y axis, or controlling movement along a 1^{st} axis and controlling movement along a 2^{nd} axis). A multiple dimensional MEMS device includes a first terminal for driving a 1^{st} axis and a second terminal for driving a 2^{nd} axis, and at least a third terminal or common terminal. With a (e.g., first) driving signal coupled into the first terminal the multiple dimensional device a change in capacitance or a variable capacitance will be provided, which includes a first variable capacitance related to movement along the 1^{st} axis of the multiple dimensional device. With a (e.g., a second) driving signal coupled into the second terminal the multiple dimensional device a change in capacitance or a variable capacitance will be provided, which includes a second variable capacitance related to movement along the 2^{nd} axis of the multiple dimensional device. A capacitance measurement system (e.g., 1020B) is coupled to one or more electrodes (e.g., a third terminal, ground terminal, or a common terminal) of a multiple dimensional MEMS device, which provides signals related to capacitances related to the 1^{st} and 2^{nd} axes. Capacitance measurement system 1020B supplies a 1^{st} axis output signal″ and a 2^{nd} axis output signal″, which characterizes a scanning pattern.

An example of a capacitive measuring system may include demodulating a first high frequency signal and/or demodulating a second high frequency signal, whereby a step of demodulating provides signals related to the capacitance(s) of the 1^{st} axis and/or 2^{nd} axis (e.g., of device 1010).

For example, a first high frequency signal and/or a second high frequency signal is coupled to device 1010 (e.g., of FIGS. 4, 5, or 6). In one embodiment, the first high frequency signal and/or the second high frequency signal are combined with (e.g., 1^{st} axis and/or 2^{nd} axis) driving signals from generators 1050 and/or 1040 and coupled to device 1010 (e.g., of FIGS. 4, 5, or 6). The driving signals from generators 1050 and 1040 provides deflection or movement in device 1010 (e.g., of FIGS. 4, 5, or 6), which provides capacitance changes related to movement/deflection in the 1^{st} axis and/or 2^{nd} axis of device (e.g., a capacitive device example of device 1010). The capacitive changes provide amplitude modulated and/or phase modulated signals to Position to Signal Converter 1020 (e.g., of FIGS. 4, 5, or 6) via input In_PSC. Position to Signal Converter 1020 may include an amplitude modulation demodulator and/or a phase modulation demodulator, which provides a 1^{st} axis output signal and/or a 2^{nd} axis output signal (e.g., FIGS. 4, 5, or 6).

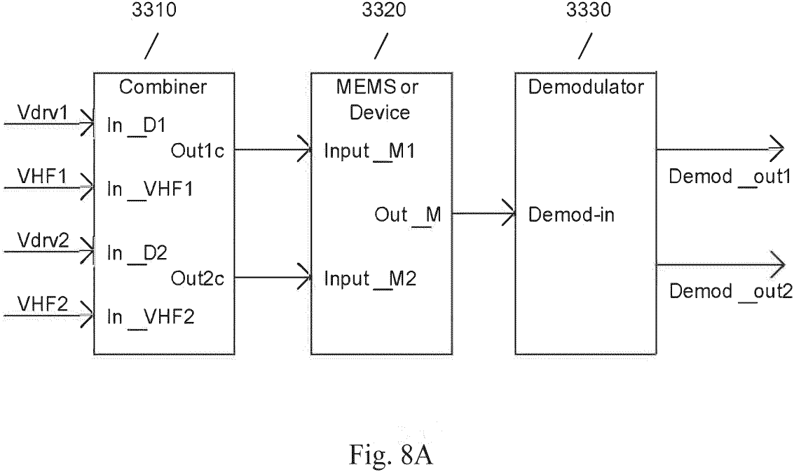

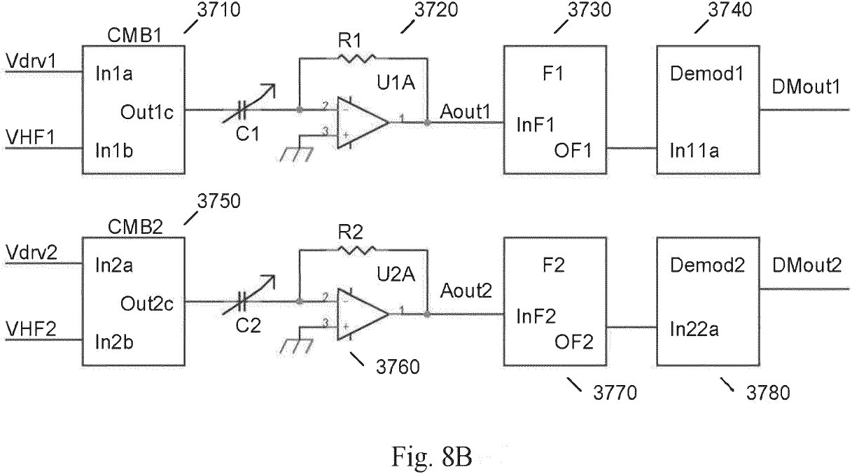

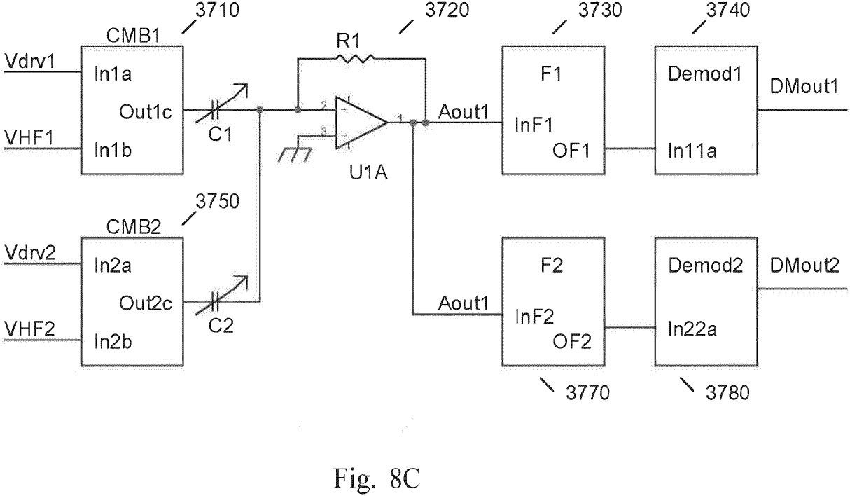

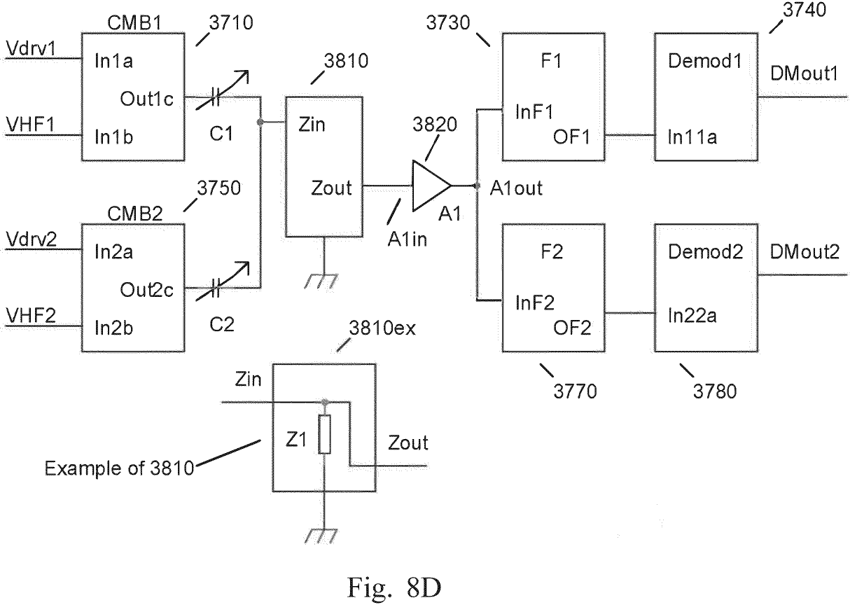

One or more examples of a capacitance measuring system including an added first high frequency signal (e.g., VHF1) and/or a second high frequency signal (e.g.,VHF2) including demodulation is illustrated in at least a portion of FIG. 8A (e.g., VHF1, VHF2, and/or 3330 in FIG. 8A), FIG. 8B (e.g., VHF1, VHF2, 3720, 3730, 3740, 3760, 3770, and/or 3780 in FIG. 8B), FIG. 8C (e.g., VHF1, VHF2, 3720, 3730, 3740, 3770, and/or 3780 in FIG. 8C), FIG. 8D (e.g., VHF1, VHF2, 3810 or 3810ex, 3730, 3740, 3770, and/or 3780 in FIG. 8D).

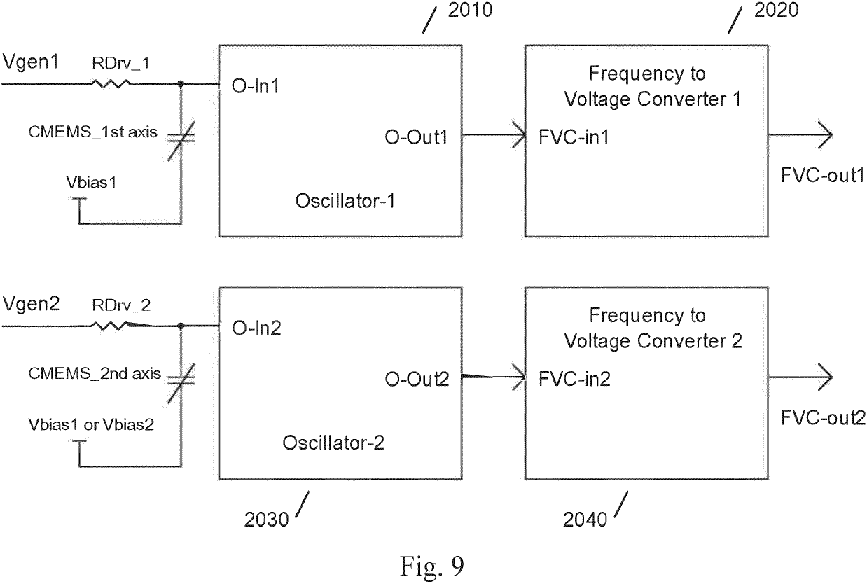

An example involving using one or more high frequency signals as part of oscillation circuit(s) is illustrated in FIG. 9. Two electrodes of Device 1010 (e.g., from FIGS. 4, 5 or 6), provides change in capacitance with one or more driving signals (e.g., Vgen1 and/or Vgen2 of FIG. 9). The two electrodes (e.g., a first electrode and a second electrode) are coupled to two oscillator circuits (e.g., a first oscillator circuit and second oscillator circuit) to establish (e.g., high) oscillation frequencies of each of the two oscillator circuits. Outputs from the oscillators are coupled to frequency to voltage converters (e.g., frequency modulation demodulators). The frequency to voltage converters in FIG. 9 provide signal FVC-out1 for a 1^{st} axis output signal (e.g., in FIGS. 4, 5, or 6) and FVC-out2 for a 2^{nd} axis output signal (e.g., in FIGS. 4, 5, or 6).

In one example, where a MEMS device is driven by two signal sources such as 1040 and 1050 (e.g., from FIG. 4, FIG. 5, and/or FIG. 6), the output signals/waveforms from PSC1 (1020A from FIG. 7) and PSC2 (1020B from FIG. 7) are substantially similar or equal to each other when normalized or scaled.

For example, in FIG. 7 with PSC2 (e.g., block 1020B):
1^{st} axis output signal’ = k₁ x 1^{st} axis output signal”
2^{nd} axis output signal’ = k₂ x 2^{nd} axis output signal”,
where k₁ and k₂ are scaling factors or constants.

An alternative embodiment/method for measuring capacitance may include an oscillator circuit and/or a demodulator circuit/function (examples of a demodulator circuit/function include: frequency modulation detector (FM detector); or frequency modulation demodulator, FM demod, FM demodulator).

Yet another embodiment/method for measuring capacitance may include adding one or more high frequency signals with the one or more drive signals and providing a capacitance measurement signal via an amplitude demodulator circuit/function or via a phase demodulator circuit/function.

FIG. 8A shows one example of a capacitance measurement system (e.g., such as a capacitance measurement system in FIG. 7) via including combiner 3310 with high frequency signal sources, VHF1 and VHF2, and with demodulator 3330. For reference and clarity of this description, a MEMS device 3320 is included, wherein device 3320 in FIG. 8A is similar to device 1010 in FIGS. 4, 5, and/or 6. A combiner, 3310, sums or adds or combines a first low frequency driving signal, Vdrv1, with a first high frequency signal VHF1. Combiner 3310 provides the combined signal including (Vdrv1 + VHF1) to output terminal Out1c and output terminal Out1c is coupled to a 1^{st} electrode of MEMS (or Device) 3320. MEMS (or Device) 3320 includes two axes of motion/movement, a 1^{st} axis and a 2^{nd} axis. The 1^{st} electrode of 3320 is illustrated as input terminal, Input_M1, which is related to the 1^{st} axis. A 1^{st} axis drive signal Vdrv1 may be provided by the output of Signal Gen1 (e.g., 1050 in FIGS. 4, 5, and/or 6).

Combiner 3310 sums or adds or combines a second low frequency driving signal, Vdrv2, with a second high frequency signal VHF2. Combiner 3310 provides the combined signal including (Vdrv2 + VHF2) to output terminal Out2c and output terminal Out2c is coupled to a 2^{nd} electrode of MEMS (or Device) 3320. The 2^{nd} electrode of 3320 is illustrated as input terminal, Input_M2, which is related to the 2^{nd} axis. A 2^{nd} axis drive signal Vdrv2 may be provided by the output of Signal Gen2 (e.g., 1040 in FIGS. 4, 5, and/or 6).

The low frequency drive signals (e.g., Vdrv1 and/or Vdrv2) supplied to the MEM (or Device) 3320 provide movement/motion/displacement along the 1^{st} and 2^{nd} axis of device 3320, which provides a change in capacitance in the 1^{st} electrode and/or in the 2^{nd} electrode. With the high frequency signals (e.g., VHF1 and/or VHF2) combined with the low frequency drive signals, a third or common terminal of the MEMS (or Device) 3320, depicted as Out_M includes varying signal (e.g., signal current) of amplitude or phase of high frequency signal(s) related to signal sources VHF1 and/or VHF2.

Output terminal Out_M of 3320 in FIG. 8A may correspond to terminal Out-Dev of 1010 in FIGS. 4, 5, or 6.

For example, by driving the Device 3320 with low frequency driving signal Vdrv1, the change in capacitance of 3320 will provide a change in amplitude and/or phase of high frequency signal VHF1 (e.g., via output terminal Out_M). By driving the Device 3320 with low frequency driving signal Vdrv2, the change in capacitance of 3320 will provide a change in amplitude and/or phase of high frequency signal VHF2 (e.g., via output terminal Out_M).

Out_M (an output signal via similarly-named output terminal) is coupled to an input terminal, Demod_in, of Demodulator 3330. Demodulator 3330 may include any combination of: amplifier circuit, filter circuit, impedance element, impedance network, synchronous detector, phase detector, demodulator circuit/function, and/or amplitude (or envelope) detector. Signals related to VHF1 and/or VHF2 are demodulated as an amplitude modulated (e.g., AM) signal and/or a phase modulated (e.g., PM) signal.

One example of Demodulator 3330 may include an amplifier, which converts signal current from Out_M (e.g., of device 3320) to a high frequency signal voltage. The high frequency signal voltage is coupled to an input terminal of a first filter to pass signals related to the frequency of VHF1 and the high frequency signal voltage may also be coupled to an input terminal of a second filter to pass signals related to the frequency of VHF2. Output signals from the first filter and second filter include amplitude modulated high frequency signals whose frequencies are related to the frequencies of VHF1 and VHF2. An output terminal of the first filter is coupled to an input terminal of a first demodulator, for example an amplitude modulation demodulator (e.g., AM detector, envelope detector, product detector, synchronous detector, amplitude modulation signal detector/demodulator; or the first demodulator may include a phase detector). An output terminal of the second filter is coupled to an input terminal of a second demodulator for example an amplitude modulation demodulator (e.g., AM detector, amplitude modulation signal detector/demodulator; the demodulator may include a phase detector).

A first output terminal (e.g., Demod_out1) from demodulator 3330 provides a signal indicative of capacitance (or capacitance changes) or scanning related to the 1^{st} axis of device 3320.

Demod_out1 may provide a 1^{st} axis output signal (e.g., FIGS. 4, 5, and/or 6).

A second output terminal (e.g., Demod_out2) from demodulator 3330 provides a signal indicative of capacitance (or capacitance changes) or scanning related to the 2^{nd} axis of device 3320.

Demod_out2 may provide a 2^{nd} axis output signal (e.g., FIGS. 4, 5, and/or 6)

With the signals Vdrv1, Vdrv2, VHF1, and VHF2 coupled to 3310, yet another implementation to measure capacitance may include coupling a third terminal or common terminal of device 3320 to an input terminal impedance network (e.g., any combination of resistor, capacitor, inductor, ceramic resonator, crystal, piezo element, and/or resonator).

The input terminal impedance network may form a filter circuit (or voltage divider circuit) with the 3320 device. With capacitance changes in 3320 via one or more drive signals, the filter circuit including the impedance network changes in phase and/or in frequency response. Changes in phase and/or frequency response due the varying capacitance of device 3320 will provide signals to a demodulator to output signals related to capacitance changes along the 1^{st} and 2^{nd} axes of the device 3320.

Signals related to changes in capacitances provide for substantially equivalent signals that form a trajectory or scanning path of the 3320 device (e.g., X-Y MEMS device).

An output terminal of the (e.g., input terminal) impedance network, which includes signals related to VHF1 and/or VHF2 (e.g., high frequency signals) may be coupled to a first and/or second amplitude modulation demodulator, or to a first and/or second phase detector. Demodulator Output terminals Demod_out1 and Demod_out2 provide signals indicative of capacitance (or capacitance changes) related to a 1^{st} and 2^{nd} axis of device 3320.

Demodulator 3330 may include an amplitude modulation demodulator/detector and/or a phase demodulator/detector. Demodulator 3330 provides an output signal, Demod_out1 (or Demod_out2), which is indicative of scanning along one axis of the Device 3320.

An embodiment described in FIG. 4, FIG. 5, and/or FIG. 6 may include one or more elements illustrated in FIG. 8A of the following: high frequency signal VHF1, high frequency signal VHF2, combiner 3310, Demodulator 3330.

In another example, in FIG. 8A, Demodulator 3330 provides a 1^{st} axis output signal via Demod_out1 and a 2^{nd} axis output signal via Demod_out2, whereby the 1^{st} axis output signal and the 2^{nd} axis output signal are shown in FIG. 4, FIG. 5, and/or FIG. 6. The Position to Signal Converter, 1020 in FIG. 4, FIG. 5, and/or FIG. 6 may include Demodulator 3330 in FIG. 8A.

FIG. 8B shows another example of measuring capacitances of a device (e.g., where device 1010 includes capacitance in FIG. 4, FIG. 5, and/or FIG. 6) and providing a 1^{st} axis output signal (e.g., via DMout1) and a 2^{nd} output axis signal (e.g., via DMout2); whereby the 1^{st} axis output signal and the 2^{nd} axis output signal are shown in FIG. 4, FIG. 5, and/or FIG. 6.

FIG. 8B shows an example embodiment including an electro-mechanical apparatus (or electrostatic device) including first axis and second axis, which is shown by variable capacitance (e.g., electrostatic) devices, C1 (e.g., a first variable capacitance device related to a first axis) and C2 (e.g., a second variable capacitance device related to a second axis).

Movement/deflection/displacement on the first axis provides a change in capacitance in C1. Movement/deflection/displacement on the second axis provides a change in capacitance of C2. By providing signals indicative of capacitance changes from C1 and/or C2, a scanning pattern or scanning trajectory can be provided (or reconstructed). A scanning pattern/trajectory or reconstructed scanning pattern from demodulated signals related to (e.g., movements from) C1 and C2 (e.g., demodulated signals provided by DMout1 and/or DMout2) substantially is equivalent to signals provided by a position sensing device (e.g., PSD) and an optical system including a light source.

Note that C1 and/or C2 may include a DC bias voltage (e.g., via Out1c from combiner CMB1 or Out2c from combiner CMB2).

In FIG. 8B a first signal, Vdrv1, is coupled to a first input terminal, In1a, of combiner, CMB1, 3710. A second signal, VHF1, is coupled to a second input terminal, In1b, of combiner, CMB1, 3710. An output terminal, Out1c, of combiner, CNM1, 3710, provides a combined or summed signal of Vdr1 and VHF1 to a first terminal of device C1. Signal source Vdrv1 provides a driving signal to provide movement/displacement/deflection of C1. For example, Vdrv1 operates at a lower frequency compared signal source VHF1. Signal source VHF1 operates at a high frequency compared to signal source Vdrv1, whereby the capacitance of C1 provides a first high frequency signal that is modulated by the movement/displacement/deflection of C1.

A first high frequency signal may include VHF1.

A second terminal of C1 provides a signal to an input to amplifier 3720, which for example may include a transimpedance amplifier, or amplifier 3720 including U1A may provide a current to voltage converter circuit. For example, capacitor current from C1 is coupled to an input of amplifier 3720 whereby an output terminal of 3720, Aout1, provides a signal voltage (e.g., via U1A and R1) indicative or related to the capacitance (or capacitance change(s)) of C1. Aout1 includes changes in amplitude of the first high frequency signal, which is related to the frequency of signal source VHF1. For example, a first high frequency signal may include VHF1. Aout1 is coupled to an input In11a of demodulator Demod1, 3740. Demodulator 3740 may include an amplitude modulation demodulator, or AM detector. Demodulator 3740 may for example include an envelope detector, multiplier, or synchronous detector. Output terminal of demodulator 3740, DMout1 provides a signal indicative of capacitance (or changes in capacitance) of C1.

Optionally, filter F1, 3730, may be included as shown in FIG. 8B. For example, filter 3730 passes signals related to (e.g., high frequency) signal VHF1 and/or any sideband signals around first high frequency signal, VHF1. If filtering is desired to for instance improve signal to noise ratio during demodulation, then Aout1 is coupled to an input terminal InF1 of 3730, and an output terminal OF1 of Filter F1, 3730, is coupled to input terminal In11a of demodulator 3740. Output terminal of demodulator 3740, DMout1 provides a signal indicative of capacitance (or changes in capacitance) of C1.

Or equivalently, Output terminal of demodulator 3740, DMout1 provides a signal indicative of position/displacement/movement/deflection provided along the first axis via device C1.

DMout1 may provide a 1^{st} axis output signal (e.g., in FIGS. 4, 5, and/or 6).

To provide a signal pertaining to movement/position/displacement/deflection from the second axis via C2, a third signal Vdrv2 and a fourth signal VHF2 are coupled to a second combiner (CMB2, 3750).

In FIG. 8B a third signal, Vdrv2,is coupled to a first input terminal, In2a, of combiner, CMB2, 3750. A fourth signal, VHF2, is coupled to a second input terminal, In2b, of combiner, CMB2, 3750. An output terminal, Out2c, of combiner, CMB2, 3750, provides a combined or summed signal of Vdr2 and VHF2 to a first terminal of device C2. Signal source Vdrv2 provides a driving signal to provide movement/displacement/deflection of C2. For example, Vdrv2 operates at a lower frequency compared signal source VHF2. Signal source VHF2 operates at a high frequency compared to signal source Vdrv2, whereby the capacitance of C2 provides a second high frequency signal that is modulated by the movement/displacement/deflection of C2.

A second high frequency signal may include VHF2.

A second terminal of C2 provides a signal to an input to amplifier 3760, which for example may include a transimpedance amplifier, or amplifier 3760 including U2A may provide a current to voltage converter circuit (e.g., U2A with R2). For example, capacitor current from C2 is coupled to an input of amplifier 3760 whereby an output terminal of 3760, Aout2, provides a signal voltage indicative or related to the capacitance (or capacitance change(s)) of C2. Aout2 includes changes in amplitude of the second high frequency signal, which is related to the frequency of signal source VHF2. Aout2 is coupled to an input In22a of demodulator Demod2, 3780. Demodulator 3780 may include an amplitude modulation demodulator, or AM detector. Demodulator 3780 may for example include an envelope detector or synchronous detector. Output terminal of demodulator 378, DMout2 provides a signal indicative of capacitance (or changes in capacitance) of C2.

DMout2 may provide a 2^{nd} axis output signal (e.g., in FIGS. 4, 5, and/or 6).

Optionally, filter F2, 3770, may be included as shown in FIG. 8B. For example, filter 3770 passes signals related to (e.g., high frequency) signal VHF2 and/or any sideband signals around second high frequency signal, VHF2. If filtering is desired to for instance improve (e.g., filtering may reduce noise) signal demodulation, then Aout2 is coupled to an input terminal InF2 of 3770, and an output terminal, OF2 of Filter F2, 3770, is coupled to input terminal In22a of demodulator 3780. Output terminal of demodulator 3780, DMout2 provides a signal indicative of capacitance (or changes in capacitance) of C2.

Or equivalently, Output terminal of demodulator 3780, DMout2 provides a signal indicative of position/displacement/movement/deflection provided along the first axis via device C2.

FIG. 8C shows an example of measuring capacitances of a device (e.g., device 1010 in FIG. 4, FIG. 5, and/or FIG. 6) and providing a 1^{st} axis output signal (e.g., via DMout1) and a 2^{nd} output axis signal (e.g., via DMout2); whereby the 1^{st} axis output signal and the 2^{nd} axis output signal are shown in FIG. 4, FIG. 5, and/or FIG. 6.

FIG. 8C shows another example whereby devices C1 and C2 include a common or third terminal that is coupled to an input terminal of amplifier 3720. The common terminal provides a combination of two high frequency signals related to the capacitance of C1 and the capacitance of C2.

In one example, a first high frequency signal source VHF1 operates at a different frequency than signal source VHF2, where source VHF2 operates at a second high frequency. A first high frequency signal may include VHF1. A second high frequency signal may include VHF2. In FIG. 8C amplifier 3720 provides an output signal Aout1 that includes signals related to the first high frequency signal, VHF1, and the second high frequency signal, VHF2, whereby signals related to the first high frequency signal and/or second high frequency signal change in amplitude when the capacitance of C1 and/or C2 changes. For example, Aout1 may include one or more amplitude modulated signals whose frequencies are related to VHF1 and/or VHF2.

Aout1 is coupled to an input terminal InF1 of filter F1, 3730, and Aout1 is coupled to an input terminal InF2 of filter F2, 3770. Filter F1 passes signals related to the first high frequency signal (e.g., VHF1) and/or any associated sidebands. Filter F2 passes signals related to the second high frequency signal (e.g., VHF2) and/or any associated sidebands. An output terminal of F1, OF1, is coupled to an input terminal of demodulator Demod1, 3740. Output terminal of demodulator 3740, DMout1 provides a signal indicative of capacitance (or changes in capacitance) of C1. Or equivalently, Output terminal of demodulator 3740, DMout1 provides a signal indicative of position/displacement/movement/deflection provided along the first axis via device C1.

DMout1 may provide a 1^{st} axis output signal (e.g., in FIGS. 4, 5, and/or 6).

Demodulator Demod1, 3740, and or Demodulator Demod2, 3780, may include an amplitude modulation demodulator or amplitude modulation detector (e.g., AM Detector), which includes for example, an envelope detector and/or a synchronous detector (e.g., a multiplier circuit/function).

An output terminal of F2, OF2, is coupled to an input terminal of demodulator Demod2, 3780. Output terminal of demodulator 3780, DMout2 provides a signal indicative of capacitance (or changes in capacitance) of C2. Or equivalently, Output terminal of demodulator 3780, DMout2 provides a signal indicative of position/displacement/movement/deflection provided along the second axis via device C2.

DMout2 may provide a 2^{nd} axis output signal (e.g., in FIGS. 4, 5, and/or 6).

Another embodiment may include quadrature signals, whereby a second high frequency signal source VHF2 has substantially a 90 degree phase difference (or substantially 90 degrees phase shift, e.g., lead or lag) from first high frequency signal source VHF1. Or VHF2 is a quadrature signal in relation to VHF1. Demodulation for example may be provided that Aout1, which include two high frequency signals that include phase difference of substantially 90 degrees, whereby the two high frequency signals are coupled to two demodulators (or synchronous detectors) such as In11a of 3740 and In22a of 3780. For example, providing synchronous detection (e.g., whereby a first reference signal related VHF1 is coupled another input (not shown) to Demod1, 3740), DMout1 provides a demodulated signal indicative of position/displacement/movement/deflection (or capacitance/capacitance change) provided along the first axis via device C1.

DMout1 may provide a 1^{st} axis output signal (e.g., in FIGS. 4, 5, and/or 6).

DMout1 may provide an output signal related to a device such as C1.

Pertaining to C2 or second axis, providing synchronous detection (e.g., whereby a second reference signal related VHF2 is coupled another input (not shown) to Demod2, 3780), DMout2 provides a demodulated signal indicative of position/displacement/movement/deflection (or capacitance/capacitance change) provided along the second axis via device C2.

DMout2 may provide a 2^{nd} axis output signal (e.g., in FIGS. 4, 5, and/or 6).

FIG. 8D shows an example of measuring capacitances of a device (e.g., device 1010 in FIG. 4, FIG. 5, and/or FIG. 6) and providing a 1^{st} axis output signal (e.g., via DMout1) and a 2^{nd} output axis signal (e.g., via DMout2); whereby the 1^{st} axis output signal and the 2^{nd} axis output signal are shown in FIG. 4, FIG. 5, and/or FIG. 6.

FIG. 8D shows another embodiment of the patent application to provide one or more signals indicative of movement/position/motion/displacement of C1 and/or C2. For example, capacitance values of C1 and/or C2 are related to movement/position/motion/displacement of C1 and/or C2. In FIG. 8D for example, at least one terminal of C1 and/or C2 is coupled to an input terminal (e.g., Zin) of an impedance circuit, network, or element, as shown in block 3810 or block 3810ex. C1 and/or C2 provides for capacitive coupling (e.g., via capacitance or capacitance change of C1 and/or via capacitance or capacitance change of C2) to Zin, an input to an impedance element or impedance circuit or impedance network. Impedance may include resistance and/or reactance. An output terminal of 3810 or 3810ex provides one or more high frequency signals related to first high frequency signal VHF1 and/or to second high frequency signal VHF2. The one or more high frequency signals related to first high frequency signal VHF1 and/or to second high frequency signal VHF2 provides a modulation of the high frequency signal related to first high frequency signal VHF1 and/or a modulation of the high frequency signal related to second high frequency signal VHF2. Modulation may include amplitude modulation and/or phase modulation. Impedance block 3810 (or 3810ex) may include a voltage divider circuit, a phase shifting circuit, and/or an amplitude frequency response circuit, wherein an output terminal (e.g., Zout) of block 3810 or block 3810ex provides an amplitude (or phase) modulated signal when C1 and/or C2 includes movement/position/motion/displacement (e.g., due to C1 and/or C2 changing in capacitance or impedance), or wherein an output terminal (e.g., Zout) of block 3810 or 3810ex provides an amplitude (or phase) modulated signal when C1 and/or C2 is performing a scan . Output signal Zout (e.g., from 3810 or 3810ex) is coupled to an input terminal (e.g., In11a) of a first demodulator Demod1, 3740, wherein an output terminal (e.g., DMout1) of demodulator 3740 provides a signal indicative of capacitance (or changes in capacitance) of C1. Or equivalently, Output terminal of demodulator 3740, DMout1 provides a signal indicative of position/displacement/movement/deflection provided along the first axis via device C1. Demodulator Demod1, 3740 may include an amplitude modulation demodulator to provide demodulation to an amplitude modulated signal, or Demodulator Demod1, 3740 may include a phase modulation demodulator to provide demodulation to a phase modulated signal. An amplitude demodulation (or AM detector) may include an envelope detector or a synchronous detector (e.g., multiplier function or circuit). A demodulator for a phase modulated signal may include a synchronous detector (e.g., a multiplier function or circuit).

Output signal Zout (e.g., from 3810 or 3810ex) is coupled to an input terminal (e.g., In22a) of a second demodulator Demod2, 3780, wherein an output terminal (e.g., DMout2) of demodulator 3780 provides a signal indicative of capacitance (or changes in capacitance) of C2. Or equivalently, Output terminal of demodulator 3780, DMout2 provides a signal indicative of position/displacement/movement/deflection provided along the second axis via device C2.

Demodulator Demod2, 3780 may include an amplitude modulation demodulator to provide demodulation to a amplitude modulated signal, or Demodulator Demod2, 3780 may include a phase modulation demodulator to provide demodulation to a phase modulated signal. An amplitude demodulation (or AM detector) may include an envelope detector or a synchronous detector (e.g., multiplier function or circuit). A demodulator for a phase modulated signal may include a synchronous detector (e.g., a multiplier function or circuit, or a phase detector).

Optionally a signal from Zout may be coupled to an input of an amplifier A1, 3820, wherein an output terminal of amplifier A1, 3820 is coupled to an input terminal, InF1 of a first filter F1. F1 passes signals related to the first high frequency signal VHF1, and associated sidebands of the first high frequency signal. Output terminal of amplifier A1, 3820 is coupled to an input terminal, InF2 of a second filter F2. F2 passes signals related to the second high frequency signal VHF2, and associated sidebands of the second high frequency signal. Output terminal of F1, OF1, is coupled to input terminal In11a of demodulator Demod1, 3740. Output terminal of F2, OF2, is coupled to input terminal In22a of demodulator Demod2, 3780. Output terminals DMout1 and DMout2 provide signals related to scanning pattern via the movement from C1 and/or C2.

Example impedance block 3810ex may include at least one element, Z1. Element Z1 may include any combination of a resistor, capacitor, and/or inductor. Alternatively, element Z1 or block 3810 may include any combination of a piezo resonator, low pass filter, high pass filter, all pass filter, phase shifting circuit, band reject filter, and/or band pass filter.

C1 and C2 may be characterized as a scanning device included in FIGS. 8A, 8B, 8C, and/or 8D.

A scanning device may be included as (e.g., device) 1010 in FIG. 4, FIG. 5, and/or FIG. 6.

Device 1010 in FIG. 4, FIG. 5, and/or FIG. 6 may include C1 and/or C2 in FIGS. 8A, 8B, 8C, and/or 8D.

US Patent 11,192,779 issued Dec. 7, 2021 includes one or more descriptions/figures for measuring or determining capacitance of a device (e.g., MEMS or electrostatic device) for one or more axis, and this patent is incorporated by reference.

FIG. 9 shows an example of measuring capacitances of a device (e.g., device 1010 in FIG. 4, FIG. 5, and/or FIG. 6) and providing a 1^{st} axis output signal (e.g., via FVC-out1) and a 2^{nd} output axis signal (e.g., via FVC-out2); whereby the 1^{st} axis output signal and the 2^{nd} axis output signal are shown in FIG. 4, FIG. 5, and/or FIG. 6.

FIG. 9 shows yet another embodiment for measuring capacitance and transforming capacitance values into a signal (e.g., voltage or current). A driving voltage for a 1^{st} axis of a MEMS device is provided by Vgen1. Capacitance via the 1^{st} axis is shown as CMEMS_1^{st} axis, which is coupled to an oscillator 2010 (e.g., via O-In1). The MEMS device may be coupled to a bias voltage Vbias 1 as shown with CMEMS_1^{st} axis (e.g., lower connection of on the schematic diagram). Oscillator 2010 provides a signal whose frequency is related to the capacitance of CMEMS_1^{st} axis, which changes in accordance to the driving source Vgen 1. An output terminal of Oscillator-1, 2010, O-Out1, is coupled to an input (FVC-in1) of Frequency to Voltage Converter 1, 2020. An output terminal of frequency to voltage converter 2020, FVC-out1 provides a signal or voltage that is related to the capacitance of the MEMS device of its 1^{st} axis (e.g., provides a signal or voltage that is related to the capacitance of CMEMS_1^{st} axis). FVC-out1 also provides a signal that is related to position/motion or scanning along the 1^{st} axis of the MEMS.

FVC-out1 may provide a 1^{st} axis output signal (e.g., in FIGS. 4, 5, and/or 6)

Similarly for providing a signal related to scanning along a 2^{nd} axis, A driving voltage for a 2^{nd} axis of a MEMS device is provided by Vgen2. Capacitance via the 2^{nd} axis is shown as CMEMS_2^{nd} axis, which is coupled to an Oscillator-2, 2030 (e.g., via O-In2). The MEMS device may be coupled to a bias voltage Vbias 1 or another bias voltage Vbias 2 as shown with CMEMS_2^{nd} axis (e.g., lower connection of on the schematic diagram). Oscillator-2, 2030, provides a signal whose frequency is related to the capacitance of CMEMS_2nd axis, which changes in accordance to the driving source Vgen 2. An output terminal of Oscillator-2, 2030, O-Out2, is coupled to an input (FVC-in2) of Frequency to Voltage Converter 2, 2040. An output terminal of frequency to voltage converter 2040, FVC-out2 provides a signal or voltage that is related to the capacitance of the MEMS device of its 2nd axis (e.g., provides a signal or voltage that is related to the capacitance of CMEMS_2^{nd} axis). FVC-out2 also provides a signal that is related to position/motion or scanning along the 2^{nd} axis of the MEMS.

FVC-out2 may provide a 2^{nd} axis output signal (e.g., in FIGS. 4, 5, and/or 6).

An example of a frequency to voltage converter includes a frequency modulation demodulator or frequency modulation detector (e.g., FM detector).

A frequency modulation detector (or frequency modulation demodulator or frequency to voltage converter) may include: a phase lock loop circuit, slope detector, a ratio detector, an FM discriminator, a quadrature FM detector, an FM ratio detector, a pulse counter and or averaging function/circuit, a differential peak detector, a derivative of a phase detector signal, an arctangent function/circuit, a software defined radio, digital signal processing function/circuit, a phase lock loop demodulator, or the like.

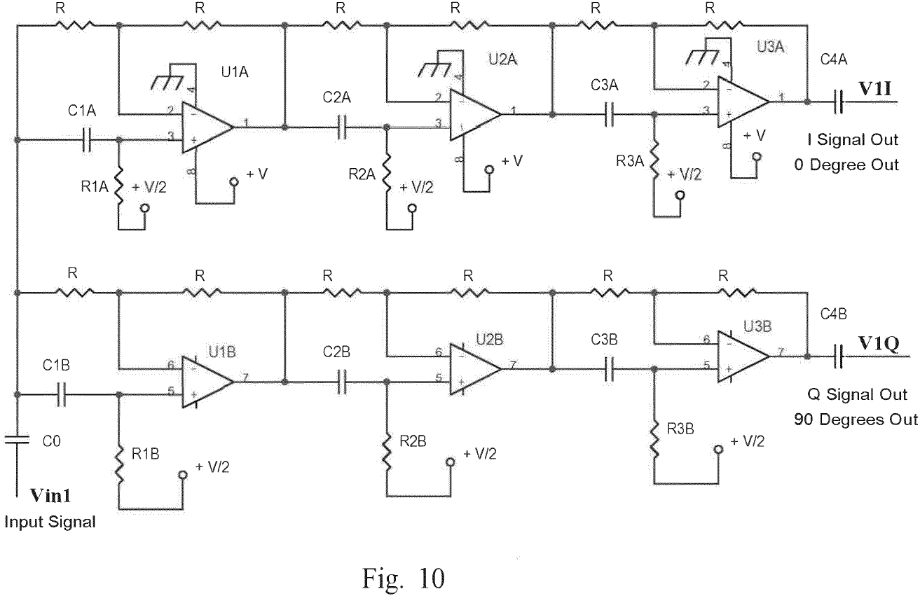

FIG. 10 shows an example of a Hilbert transform for a 1^{st} axis signal (e.g., 1^{st} axis output signal from a Position to Signal Converter of FIGS. 4, 5, or 6 is coupled to Vin1 of FIG. 10).

FIG. 10 shows an example of a Hilbert transform circuit. A 1^{st} axis output signal from a Position to Signal Converter is coupled (e.g., via Vin1) to a set of phase shifting circuits. A zero degree signal output is provided via VII, and a 90 degrees signal output is provided via V1Q. With U1A, U2A, U3A and their associate components R1A, C1A, R2A, C2A, R3A, and C3A, an accumulated phase shift at VII as a function of frequency, f, is:

$$\begin{matrix}{\text{ϕ}}_{\text{Itotal}} = \left[\text{180} \text{degrees} - {\text{2tan}}^{\text{-1}} \left(\text{f} / \text{f1a}\right)\right] + \\ \left[\text{180} \text{degrees} - {\text{2tan}}^{\text{-1}} \left(\text{f} / \text{f2a}\right)\right] + \left[\text{180} \text{degrees} - {\text{2tan}}^{\text{-1}} \left(\text{f} / \text{f3a}\right)\right]\end{matrix}$$

Where f1a = ⅟(2πR1AC1A), f2a = ⅟(2πR2AC2A), and f3a = ⅟(2πR3AC3A).

Similarly at V1Q the accumulated phase shift with the circuit from U1B, U2B, and U3B is:

$$\begin{matrix}{\text{ϕ}}_{\text{Qtotal}} = \left[\text{180} \text{degrees} - {\text{2tan}}^{\text{-1}} \left(\text{f} / \text{f1b}\right)\right] + \\ \left[\text{180} \text{degrees} - {\text{2tan}}^{\text{-1}} \left(\text{f} / \text{f2b}\right)\right] + \left[\text{180} \text{degrees} - {\text{2tan}}^{\text{-1}} \left(\text{f} / \text{f3b}\right)\right]\end{matrix}$$

Where f1b = ⅟(2πR1BC1B), f2b = ⅟(2πR2BC2B), and f3b = ⅟(2πR3BC3B) Where |(ϕ_{Itotal} - ϕ_{Qtotal})| = 90 degrees over a range of frequencies or substantially 90 degrees over a range of frequencies.

With three stages (e.g., three pairs) of op amps, this Hilbert transform circuit in FIG. 10 provides accuracy of better than half a degree (e.g., with perfect component tolerance value the accuracy is within +/- 0.1 degree) over a decade range of frequency (e.g., 300 Hz to 3000 Hz, 600 Hz to 6000 Hz, etc.).

For narrower range of frequencies, one pair or two pairs of amplifiers can suffice wherein the I and Q signal outputs may be provided via the output terminals of U1A and U1B (for one pair or one stage), or from output terminals of U2A and U2B (for two pairs or two stages).

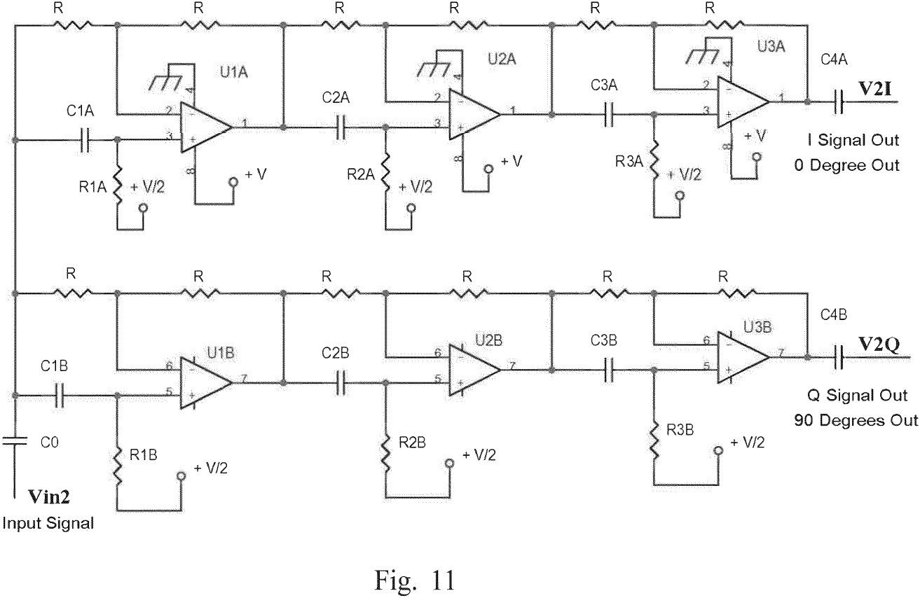

FIG. 11 shows a similar or equivalent circuit for providing Hilbert transform signals for a 2^{nd} axis signal for example 2^{nd} axis output signal from a Position to Signal Converter of FIGS. 1, 2, or 3 is coupled to Vin2 of FIG. 1. I and Q output signals are provided via V2I (e.g., 0 degree) and V2Q (e.g., 90 degrees phase shift from V2I).

Alternative versions of the implementation(s) found in FIG. 10 and/or FIG. 11 may include swapping the resistors and capacitors that form the phase shifting effect. For example for one set of resistor and capacitor, in FIG. 10 capacitor C1A and resistor R1A form a high pass filter circuit. An alternative Hilbert circuit would replace the C1A capacitor with the resistor R1A and replace the resistor R1A with capacitor C1A, and repeat this process for all the other resistors and capacitors in the circuit related to forming phase shifting. This swapping of components forms low pass filters instead of high pass filters, which will also provide I and Q output signals.

Hilbert transform functions or circuits may be implemented by other methods such as with digital signal processing (DSP), mixing, multiplying, one or more functions in software defined radio, or with Polyphase circuits. Other circuits that can implement a Hilbert transform (e.g., over a specific frequency or over a range of frequencies) include one or more circuits (e.g., all pass, band pass, high pass, band eject, low pass, multiplier, mixer, heterodyning, I Q mixing circuit/function, Weaver I Q circuit, and/or delay circuits).

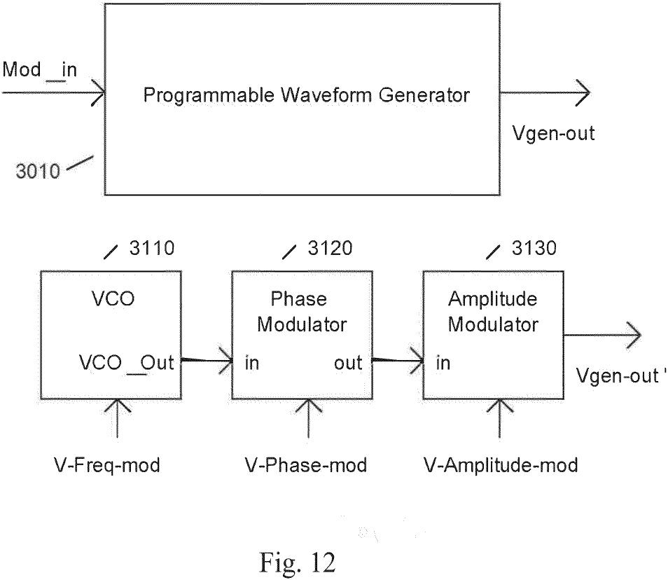

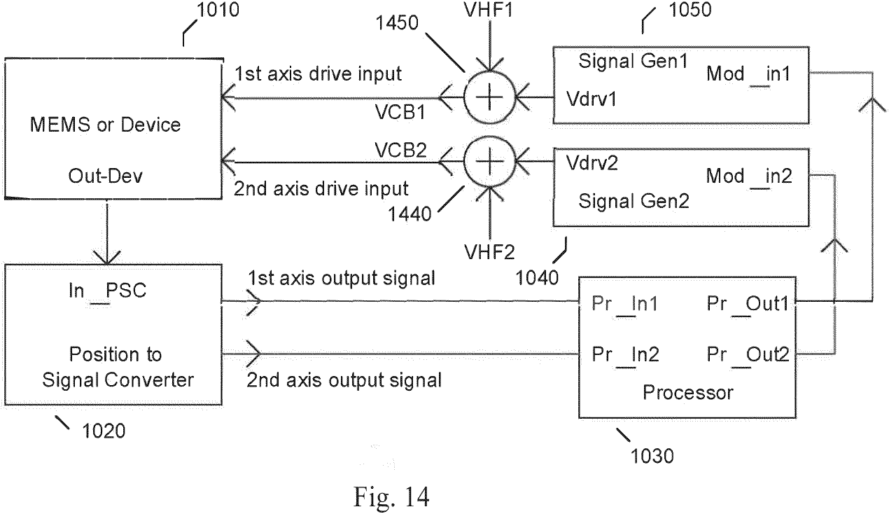

FIG. 12 shows example of signal generators to provide modulated (or predetermined) waveforms or modulated (or predetermined) signals. In one example, Programmable Waveform Generator, 3010, may receive an input signal at terminal Mod_in from a processor output signal (e.g., Pr_Out1 or Pr_Out2 from processor 1030, 1030A, or 1030B via FIG. 4, FIG. 5, FIG. 6, or FIG. 14), which provides at Vgen-out of FIG. 12, a waveform of predetermined frequency, phase, and/or amplitude to drive a device (e.g., 1010 in FIG. 4, FIG. 5, FIG. 6, or FIG. 14) for optimal scanning or for scanning a predetermined scanning pattern.

In another example, Programmable Waveform Generator, 3010, may receive an input signal at terminal Mod_in from a processor output signal (e.g., Pr_Out1 or Pr_Out2 from processor 1030, 1030A, or 1030B via FIG. 4 or FIG. 14, FIG. 5, or FIG. 6), which provides at Vgen-out of FIG. 12, a modulated signal. Vgen-out of 3010 includes modulation of any combination of: frequency, phase, and/or amplitude. The modulated signal is to drive a device (e.g., 1010 in FIG. 4, FIG. 5, FIG. 6, or FIG. 14) for optimal scanning or for scanning a predetermined scanning pattern.

Processor 1030 from FIG. 4 (or FIG. 5, FIG. 6, or FIG. 14) may provide an output signal Pr_Out1 and/or Pr_Out2 to a programmable signal generator (e.g., via Mod_in of 3010 in FIG. 12) to provide/supply a waveform/signal (e.g., via Vgen-out of FIG. 12 that provides a 1^{st} axis drive signal and/or 2^{nd} axis drive signal) of predetermined frequency, phase, and/or amplitude with any combination of: frequency modulation, phase modulation, and/or amplitude modulation.

For a multi-dimensional scanning device, two Programmable Signal Generators of 3010 may be used where a first Programmable Signal Generator receives a processor signal (e.g., Pr_Out1 from FIG. 4, FIG. 5, FIG. 6, or FIG. 14) via a Mod_in input terminal, and wherein via Vgen-out from the first Programmable Signal Generator provides a 1^{st} axis drive signal to a device (e.g., 1010 from FIG. 4, FIG. 5, FIG. 6, or FIG. 14). Similarly a second Programmable Signal Generator receives a processor signal (e.g., Pr_Out2 from FIG. 4, FIG. 5, FIG. 6, or FIG. 14) via a Mod_in input terminal (of the second Programmable Signal Generator), and wherein via Vgen-out from the second Programmable Signal Generator provides a 2^{nd} axis drive signal to a device (e.g., 1010 from FIG. 4, FIG. 5, FIG. 6, or FIG. 14).

Vdrv1 (e.g., as shown in FIGS. 8A, 8B, 8C, or 8D) may include a 1^{st} axis drive input signal (e.g., to device 1010) or an output signal from Signal Gen 1 (e.g., 1050, 1050A′, 3130, or 3010).

Vdrv1 (or Vdrv2) may include one or more tones (or signals) for scanning.

Vdrv2 (e.g., as shown in FIGS. 8A, 8B, 8C, or 8D) may include 2^{nd} axis drive input signal (e.g., to device 1010) or output signal from Signal Gen 2 (e.g., 1040, 1040A′, 3130, or 3010).

For example, a programmable signal generator (e.g., including direct digital synthesis, DDS) of providing a waveform is shown in block 3010. A programmable or DDS signal generator may include a modulation (or a programming waveform) input terminal, Mod_in, wherein when the programmable or DDS signal generator provides a generator signal of a first generator frequency, the modulation (or programming waveform) input allows or provides for the generator signal of the first generator frequency to be modulated with a signal having a modulation frequency. Modulation may include amplitude, phase, and or frequency modulation. Vgen-out from 3010 provides a modulated signal, which may include amplitude, phase, and or frequency modulation. For example, the modulation input terminal Mod_in may be coupled to a processor (e.g., 1030 of FIG. 4 or FIG. 14, 1030A of FIG. 5, or 1030B of FIG. 6) output signal such as Pr_Out1 or Pr_Out2. An amplitude of a signal coupled to a modulation input terminal, Mod_in, may control or provide an amount of modulation in terms of amplitude modulation, amplitude level, frequency shift, frequency modulation, phase modulation, and/or phase shift at the output signal of 3010 (e.g., output signal Vgen_out from 3010).

Another example of a signal generator, which includes a capability of modulating a waveform in terms of amplitude modulation, phase modulation, and/or frequency modulation is shown in blocks 3110, 3120, and 3130 of FIG. 12. For example a voltage controlled oscillator, VCO, may be included in block 3110, which provides an oscillator signal from the VCO. A frequency control input terminal V-Freq-mod can vary the oscillator frequency of the VCO. The output (e.g., VCO_out) of the VCO 3110 is coupled to an input of a phase modulator 3120, which allows a capability of phase modulating the output of the VCO signal via phase modulator input terminal V-Phase-mod. The phase modulator output signal is coupled to an amplitude modulator 3130, which provides a capability of amplitude modulating the signal from 3120 via amplitude modulation input terminal V-Amplitude-mod. An output signal from 3130, Vgen-out’ provides a signal whose frequency can be modulated, whose phase can be modulated, and/or whose amplitude can be modulated. Vgen-out’ provides a signal that may include any combination of frequency modulation, phase, modulation, and/or amplitude modulation. One or more output signals from processor 1030, 1030A, or 1030B (e.g., Pr_Out1 and or Pr_Out2 or other processor output signals) may be coupled to any combination of the V-Freq-mod, V-Phase-mod, and/or V-Amplitude-mod input terminals. Vgen-out’ may provide a 1^{st} or 2^{nd} axis drive input signal to a device (e.g., 1010).

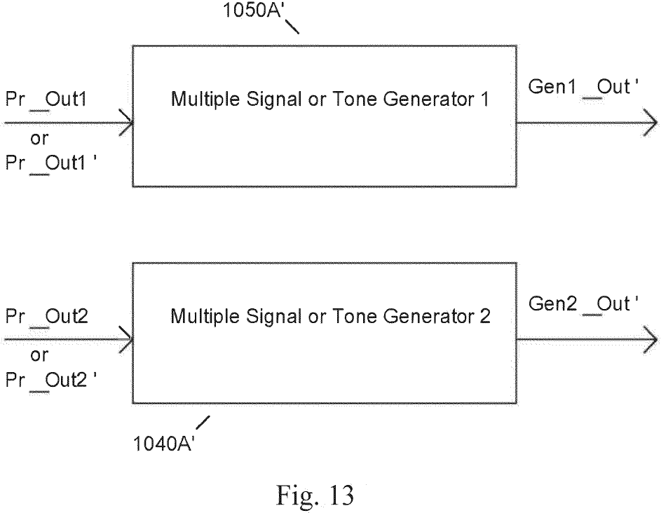

FIG. 13 shows another embodiment for signal generation for providing a drive signal (e.g., drive signal to a MEMS device) via combining two or more signals of different frequencies. Generator 1050A′ includes providing two or more signals (e.g., to a device such as 1010) for scanning. By combining or using two or more signals (or tones), a modulated signal is provided. For example, two signals or tones combined mathematically results to include a (e.g., a form of a) double sideband suppressed carrier signal. Two signals combined may represent a single sideband signal with carrier. Two signals combined may represent a vestigial side band signal. Generator 1050′ provides multiple signals wherein the frequencies of the multiple signals are different, and whereby the phase and/or amplitude of each signal from the multiple signals may be selected, synthesized, generated, or predetermined.

For example, with three signals combined of different frequencies, an amplitude modulated signal, frequency modulated signal, and/or phase modulated signal may be provided. In another example, three signals can represent a lower sideband signal, a carrier (or center frequency) signal, and an upper sideband signal. The lower sideband signal may be altered in phase and/or amplitude; and/or the carrier signal may be altered in phase and/or amplitude; and/or the upper sideband signal may be altered in phase and/or amplitude. Gen1- Out′ may be utilized for driving a 1^{st} axis of device. Providing specific multiple signals at Gen1_Out′ may be determined via a signal from processor 1030, 1030A, or 1030B such as Pr_Out, or another signal from processor 1030, 1030A, or 1030B.

Generator 1040A′, which includes features/characteristics of 1050A′ may be utilized for driving a 2^{nd} axis device. Providing specific multiple signals at Gen2_Out′ may be determined via a signal from processor 1030, 1030A, or 1030B such as Pr_Out2, or another signal from processor 1030, 1030A, or 1030B.

FIG. 14 shows an example similar to FIG. 4, whereby high frequency signals are added/combined and coupled into device 1010. FIG. 14 illustrates providing a first high frequency signal, VHF1 combined with a first driving signal or a first low frequency signal, Vdrv1, from signal generator 1050. A combiner 1450 receives VHF1 and Vdrv1 to provide a combined output signal VCB1. VCB1 may be a linear combination of VHF1 and Vdrv1. Combined signal VCB1 is coupled to a 1^{st} axis drive input (e.g., terminal) of device 1010.

For example, VCB1 = VHF1 + Vdrv1. Other linear combinations of VHF1 and Vdrv1 can be provided such as VCB1 = α₁ VHF1 + β₁ Vdrv1, where α₁ and β₁ are constants.

Similarly for providing a combined signal to the 2^{nd} axis drive input (e.g., terminal) of 1010, output signal Vdrv2 (a second driving signal or second low frequency signal) from Signal Gen2 is combined with a second high frequency signal, VHF2 via combiner 1440. Combiner 1440 receives signals Vdrv2 and VHF2, and an output terminal of combiner 1440 provides a second combined signal, VCB2. Combined signal VCB2 is coupled to a 2^{nd} axis drive input (e.g., terminal) of device 1010.

For example, VCB2 = VHF2 + Vdrv2. Other linear combinations of VHF2 and Vdrv2 can be provided such as VCB2 = α₂ VHF2 + β₂ Vdrv2, where α₂ and β₂ are constants.

Operation of the system shown in FIG. 14 is substantially the same as the system shown in FIG. 4. The high frequency signals VHF1 and VHF2 are coupled to via output terminal of 1010, Out-Dev, to an input terminal of Position to Signal Converter 1020. Position to Signal Converter includes one or more demodulators for signals related to VHF1 and VHF2. Demodulation of signals related to VHF1 and VHF2 include amplitude demodulation and/or phase demodulation). Position or motion of device 1010 provides changes in capacitance for a 1^{st} axis and/or a 2^{nd} axis. The changes in capacitance via device 1010 provide one or more amplitude modulated signals and/or phase modulated signals. In one example, Position to Signal Converter 1020 includes an amplitude modulation demodulator. In another example, Position to Signal Converter, 1020, includes a phase modulation demodulator.

The demodulated signal related to VHF1 provides a 1^{st} axis output signal from 1020.

The demodulated signal related to VHF2 provides a 2^{nd} axis output signal from 1020.

Similarly, in FIG. 14 signals, VHF1 and VHF2, and combiners, 1440 and 1450, may be applied to FIG. 5, and FIG. 6.

By using high frequency signals for demodulation, the system shown in FIG. 14 does not require an optical method/apparatus (e.g., with a light source and with light coupled to a PSD) to provide a 1^{st} axis output signal and/or a 2^{nd} axis output signal. Capacitance changes in device 1010 due to the driving signals (e.g., Vdrv1 and/or Vdrv2) with demodulator signals provide substantially an accurate representation of the scanning pattern or scanning motion of device 1010.

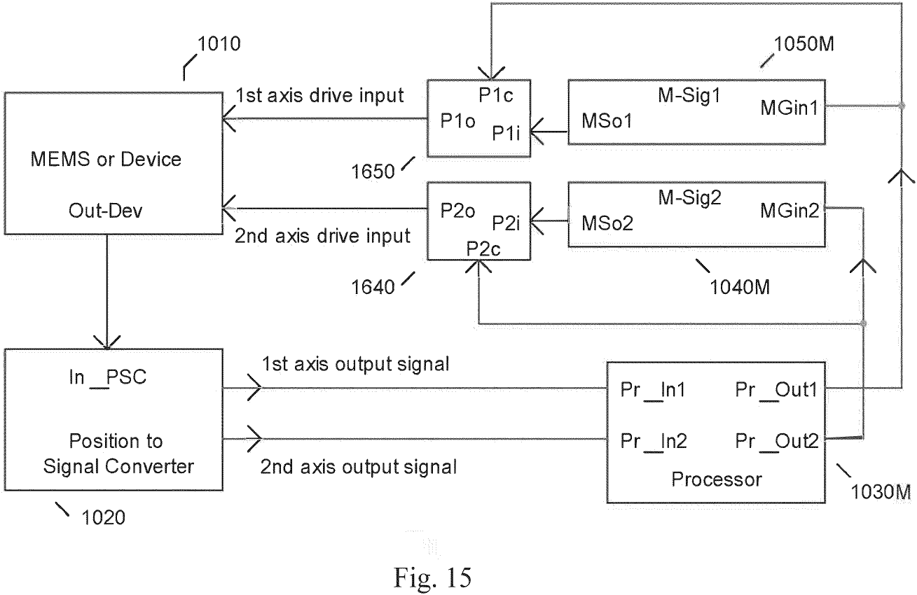

FIG. 15 shows an embodiment of the application wherein the MEMS or Device 1010 is supplied with a first axis drive signal coupled to a 1^{st} axis drive input terminal via phase shifting block 1650, P1o. A first modulated signal may be characterized as an amplitude modulation signal and/or phase modulated signal wherein the first modulated signal via output terminal MSol of signal generator 1050M, is coupled to an input of a filter, filter bank, phase shifting bank, or phase shifting apparatus/function, 1650 via input P1i. The first modulated signal may include a lower sideband signal, a carrier signal (or center frequency signal), and/or an upper sideband signal. The output of the phase shifting block 1650 via output terminal P1o provides for a programmed or predetermined phase shift of each of the lower sideband signal, carrier signal (or center frequency signal), and/or upper sideband signal related to the first modulated signal. For example, phase shifting block 1650 may provide for a first phase shift value to the lower sideband signal, a second phase shift value to the carrier signal, and/or a third phase shift value to the upper sideband signal (e.g., as related to the first modulated signal via MSo1). Processor 1030M0 via Pr_Out1 provides one or more control/programming signals to a control/programming input terminal, P1c of phase shifting block 1650. Signal Pr_out1 may be coupled to input terminal MGin1 of generator 1050M to provide for adjusting amplitude of the signal from output terminal MS01. The output terminal, P1o of 1650 then provides three signals (e.g., a lower sideband signal, a carrier signal (or center frequency signal), and/or an upper sideband signal) wherein each of the three signals may be provided with a predetermined or programmed (or modulated) phase shift (e.g., related to the modulated signal from MSo1). For example, three signals each with predetermined/adjusted phase are coupled to the 1^{st} drive input terminal of MEMS or Device 1010, wherein the three signals provide for a modulated signal with phase adjustments of one or more of its components (e.g., components of a modulated signal are lower sideband signal, carrier signal (or center frequency), and/or upper sideband signal).

Phase adjustment(s) may (e.g., further) include a modulation of any combination of the lower sideband signal, carrier signal (or center frequency), and/or upper sideband signal; wherein modulation include amplitude modulation, phase modulation, and/or frequency modulation.

It should be noted if the first modulated signal has its modulation turned off the signal, output signal from MSo1 (1050M) includes a carrier signal (or center frequency signal) without a lower sideband signal (or an upper sideband signal), wherein the carrier signal (or center frequency signal) in an unmodulated example will drive the first axis of the MEMS or Device 1010.

Similarly for providing a signal to the 2^{nd} axis drive input of MEMS or Device 1010, is supplied with a second axis drive signal coupled to a 2nd axis drive input terminal via phase shifting block 1640, P2o. A second modulated signal may be characterized as an amplitude modulation signal and/or phase modulated signal wherein the second modulated signal via output terminal MSo2 of signal generator 1040M, is coupled to an input of a filter, filter bank, phase shifting bank, or phase shifting apparatus/function, 1640 via input P2i. The second modulated signal may include a lower sideband signal, a carrier signal, and/or an upper sideband signal. The output of the phase shifting block 1640 via output terminal P2o provides for a programmed or predetermined (or modulated) phase shift of each of the lower sideband signal, carrier signal (or center frequency signal), and/or upper sideband signal related to the second modulated signal. For example, phase shifting block 1640 may provide for a first phase shift value to the lower sideband signal, a second phase shift value to the carrier signal, and/or a third phase shift value to the upper sideband signal (e.g., as related to the second modulated signal via MSo2). Processor 1030M0 via Pr_Out2 provides one or more control/programming signals to a control/programming input terminal, P2c of phase shifting block 1640. Signal Pr_Out2 may be coupled to input terminal MGin2 of generator 1050M to provide for adjusting amplitude of the signal from output terminal MSol. The output terminal, P2o of 1640 then provides three signals (e.g., a lower sideband signal, a carrier signal (or center frequency signal), and/or an upper sideband signal) wherein each of the three signals may be provided with a predetermined or programmed (or modulated) phase shift (e.g., related to the modulated signal from MSo2). For example, three signals each with predetermined/adjusted phase are coupled to the 2^{nd} drive input terminal of MEMS or Device 1010, wherein the three signals provide for a modulated signal with phase adjustments of one or more of its components (e.g., components of a modulated signal are lower sideband signal, carrier signal (or center frequency signal), and/or upper sideband signal).

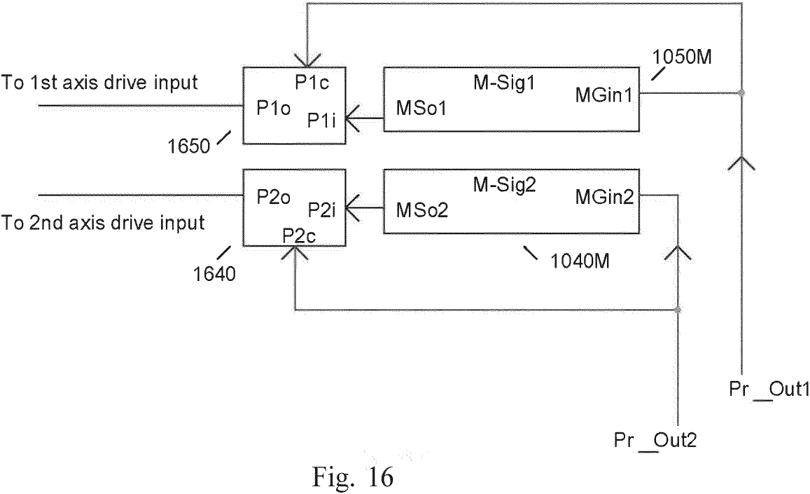

FIG. 16 shows the block 1050M with block 1650, and block 1040M with block 1640, which may be used to replace generators 1050 and 1040 in FIGS. 4, 5, 6, and/or FIG. 14. Blocks 1040M, 1050M, 1650, and 1640 provide for providing predetermined phase for lower sideband signal, carrier signal (or center frequency signal), and/or upper signal, and wherein the output terminal of 1650, P1o supplies a 1^{st} axis drive signal and/or the output terminal of 1640, P2o, supplies a 2^{nd} axis drive signal. Also more detailed description of Blocks 1040M, 1050M, 1650, and 164 can be found in the previous paragraphs pertaining to FIG. 15.

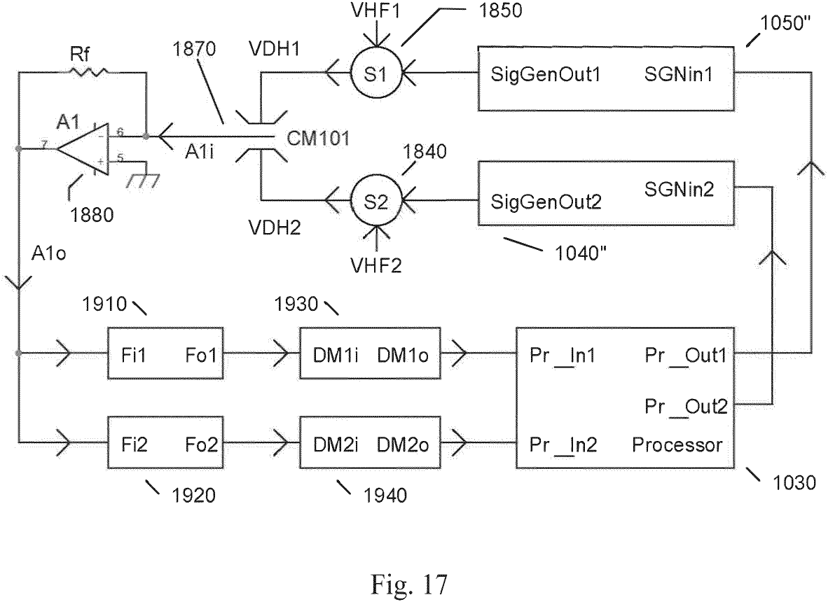

FIG. 17 shows an embodiment of the patent application wherein a capacitive device (e.g., 1870 or CM101) is utilized for scanning. Device 1870 includes a 1^{st} axis driving terminal, a 2^{nd} axis driving terminal, and at least a third terminal or common terminal. A first axis driving signal via generator 1050″ is combined (e.g., via combiner 1850) with a first axis high frequency signal, VHF1, which provides a first composite signal, VDH1, that is coupled to the 1^{st} axis driving terminal of device 1870. A second axis driving signal via signal generator 1040″ is combined (e.g., via combiner 1840) with a second axis high frequency signal, VHF2, which provides a second composite signal, VDH2, that is coupled to the 2^{nd} axis driving terminal of device 1870. The third or common terminal of device 1870 is coupled to an amplifier. With device 1870 scanning or operating capacitance(s) related to CM101 will vary, which then provide signals via the third or common terminal of device 1870 that include amplitude varying signals related to the frequencies of signals VHF1 and/or VHF2. Amplifier 1880 output signal, A1o, provides two high frequency signals related to the frequencies of VHF1 and VHF2, which are then coupled to input terminals (DM1i and DM2i) of demodulators 1930 and 1940. Demodulators 1930 and 1940 may include amplitude modulation demodulator(s) or synchronous demodulator(s), which output a 1^{st} axis output signal via DM1o and output a 2^{nd} axis output signal via DM2o. Demodulator output terminal DM1o is coupled to a processor 1030 input terminal Pr_In1. Demodulator output terminal DM2o is couple to processor 1030 input terminal Pr_In2.

Output signals from the demodulators 1930 and 1940 via DM1o and DM2o provide signals related to position or motion along the first axis and along the second axis of device 1870 (or CM101). The demodulator output signals from DM1o and DM2o provide signals that are indicative of a scanning pattern or a scanning trajectory.

Processor 1030 may include computing or measuring phase angle (e.g., phase lag or phase lead) of the 1^{st} axis output signal from DM1o and/or measuring phase angle (e.g., phase lag or phase lead) from the 2^{nd} axis output signal from DM2o.

Processor 1030 couples output signal Pr_Out1 to an input terminal (e.g., SGNin1) of first axis driving signal generator 1050″ and/or processor 1030 couples output signal Pr_Out2 to an input terminal (e.g., SGNin2) of second axis driving signal generator 1040″.

Signal generator 1050″ provides an output signal via terminal SigGenOut1 to be coupled to the first axis driving terminal of device 1870. Signal generator 1040″ provides an output signal via terminal SigGenOut2 to be coupled to the second axis driving terminal of device 1870.

Output signal from SigGenOut1 may provide a predetermined or modulated waveform as programmed or modulated via the signal from Pr_Out1 coupled to SGNIn1. For example, SigGenOut1 may include an amplitude modulated signal and/or a phase modulated signal, which includes two of more signal components. The two or more signal components may include any combination of a lower sideband signal, a center frequency signal (or a carrier signal), and/or an upper sideband signal. Any or each of the signal components (e.g., lower sideband signal, a center frequency signal (or a carrier signal), and/or an upper sideband signal) may further be phase shifted to a predetermined phase angle (e.g., predetermined lag phase shift, predetermined lead phase shift, or predetermined zero (or substantially close to zero) phase shift).

In one example, providing a set phase, phase shift, phase modulation, or predetermined phase value to the two of more signal components (e.g., lower sideband signal, a center frequency signal (or a carrier signal), and/or an upper sideband signal) may provide for an optimal scanning pattern (e.g., in a region of interest) via a scanning device (e.g., such as a scanning device 1010, 1870, CM101, an electrostatic device, or an electromechanical device).

Output signal from SigGenOut2 may provide a predetermined or modulated waveform as programmed or modulated via the signal from Pr_Out2 coupled to SGNIn2.

SigGenOut2 (or SigGenOut1) may include an amplitude modulated signal and/or a phase modulated signal, which includes two of more signal components. The two or more signal components may include any combination of a lower sideband signal, a center frequency signal (or a carrier signal), and/or an upper sideband signal. Any or each of the signal components (e.g., lower sideband signal, a center frequency signal (or a carrier signal), and/or an upper sideband signal) may further be phase shifted to a predetermined phase angle (e.g., predetermined lag phase shift, predetermined lead phase shift, or predetermined zero (or substantially close to zero) phase shift).

FIG. 17 shows optionally filters 1910 and 1920, which may include for example band pass filters. For example, filter 1910 may pass signals whose frequencies are related to VHF1 or filter 1910 passes signals related to any (e.g., selected) sideband signal, carrier signal, center frequency signal or signal component(s) related to VHF1. Filter 1920 may pass signals whose frequencies are related to VHF2 or filter 1920 passes signals related to any (e.g., selected) sideband signal, carrier signal, center frequency signal or signal component(s) related to VHF2. For example, filter 1910 and/or filter 1920 may include at least of: a band pass filter, a low pass filter, a high pass filter, and/or a band reject filter. Filter 1910 includes an input terminal Fi1 and an output terminal Fo1. Filter 1920 includes an input terminal Fi2 and an output terminal Fo2. For example, amplifier A1 1880 output signal A1o is coupled to filter input terminals Fi1 and Fi2. The output terminal of filter 1910, Fo1, is coupled to an input terminal of demodulator 1930 via input terminal DM1i. The output terminal of filter 1920, Fo2, is coupled to an input terminal of demodulator 1940 via input terminal DM2i.

In terms of other devices similar to CM101 or 1870, some devices may include up to four driving terminals with a fifth or common terminal (or lead). For example, with a typical device that utilizes differential or push pull driving signal for each axis, 4 driving terminals are included, such as an X⁻ terminal and an X⁺ terminal for driving an X axis and a Y⁻ terminal and an Y⁺ terminal for driving a Y axis. In an example of a scanning device with four driving terminals additional high frequency signals and/or demodulators may be included or required. For example, a system or apparatus may include four high frequency signals, VHF1, VHF2, VHF3, and VHF4; wherein high frequency signal VHF1 is combined with a first X axis driving signal, which then couples to an X⁻ terminal, and signal VHF3 is combined with second X axis driving signal, which then couples to an X⁺ terminal. Similarly, high frequency signal VHF2 is combined with a first Y axis driving signal, which then couples to a Y⁻ terminal, and high frequency signal VHF4 is combined with second Y axis driving signal, which then couples to a Y⁺ terminal. In this example, amplifier A1, 1880, will output four high frequency signals (e.g., via output signal A1o) that include amplitude and/or phase variations as a result of the scanning device scanning or moving. Output signal Alo is coupled to input terminals of four demodulators. The output terminals of the demodulators are combined in a manner to provide a signal (e.g., 1^{st} axis output signal) indicative of movement along the X axis and to provide a signal (e.g., 2^{nd} axis output signal) indicative of movement along the Y axis. The signal (e.g., 1^{st} axis output signal) indicative of movement along the X axis is coupled to a first input terminal (e.g., Pr_In1) of Processor 1030, and the signal (e.g., 2^{nd} axis output signal) indicative of movement along the Y axis is coupled to a second input terminal (e.g., Pr_In2) of Processor 1030. More examples of four terminal devices with capacitance measurement systems that may be utilized in this Patent Application may be found in U.S. Pat. 11,192,779 issued Dec. 7, 2021, which includes one or more descriptions/figures for measuring or determining capacitance of a device (e.g., MEMS or electrostatic device) for one or more axis, and this patent is incorporated by reference.

The scanning device operating provides capacitance changes related to the four driving terminals. For example these capacitance changes can be characterized as four variable capacitors (e.g., Cₓ₋, Cₓ₊, C_{y-}, and/or C_{y+}) with each variable capacitor providing a signal current via high frequency signal sources VHF1, VHF2, VHF3, and/or VHF4. For example, a signal current related to the X⁻ terminal can be characterized as:

$$\begin{matrix}\left|{\text{I}}_{\text{ac\_capacitor\_x-}}\right| = \left(\left|\text{VHF1}\right|\right) \times {\text{ω}}_{1} {\text{C}}_{\text{x-}} \\ \text{where} {\text{ω}}_{1} = 2 π {\text{f}}_{\text{1}} \text{and} {\text{f}}_{\text{1}} = \text{frequency} \text{related} \text{to} \text{VHF1}\end{matrix}$$

For the X⁺ terminal of the four terminal scanning device in this example:

$$\begin{matrix}\left|{\text{I}}_{\text{ac\_capacitor\_x+}}\right| = \left(\left|\text{VHF3}\right|\right) \times {\text{ω}}_{3} {\text{C}}_{\text{x+}} \\ \text{where} {\text{ω}}_{3} = 2 π {\text{f}}_{\text{1}} \text{and} {\text{f}}_{3} = \text{frequency} \text{related} \text{to} \text{VHF3}\end{matrix}$$

For signal currents related to the Y axis:

$$\begin{matrix}\left|{\text{I}}_{\text{ac\_capacitor\_y-}}\right| = \left(\left|\text{VHF2}\right|\right) \times {\text{ω}}_{2} {\text{C}}_{\text{y-}} \\ \text{where} {\text{ω}}_{2} = 2 π {\text{f}}_{2} \text{and} {\text{f}}_{2} = \text{frequency} \text{related} \text{to} \text{VHF2}\end{matrix}$$

$$\begin{matrix}\left|{\text{I}}_{\text{ac\_capacitor\_y+}}\right| = \left(\left|\text{VHF4}\right|\right) \times {\text{ω}}_{4} {\text{C}}_{\text{y+}} \\ \text{where} {\text{ω}}_{4} = 2 π {\text{f}}_{4} \text{and} {\text{f}}_{4} = \text{frequency} \text{related} \text{to} \text{VHF4}\end{matrix}$$

Example frequencies for high frequency signals can be at least 20 kHz. For example, the frequency range used in VHF1, VHF2, VHF3, and/or VHF4 can be within a 20 kHz to 10 MHz. Other frequency ranges are useable for the high frequency signals. High frequency signals described in this patent application are included to facilitate measuring capacitance. Normally these high frequency signals do not contribute in causing movement of a scanning device.

Drive signals are signals that operate at lower frequencies that contribute to providing movement in a scanning device.

Processor 1030, 1030A, 1030B, and/or 1030M0 (e.g., of FIGS. 4, 5, 6, 15, and/or 44) receives and processes signals from one or more demodulators (or from one a multiple dimensional position signal device, PSD). Output signals from processor 1030, 1030A, and/or 1030B include signals to program, instruct, or set parameters to one or more signal generators to drive a scanning device, wherein the scanning device provides a scanning pattern includes an optimal (or optimized) scanning pattern for a region of interest for a given field of view. Parameters pertaining to one or more signal generators include: amplitude, modulation index, modulating signal, phase, frequency of one or more signal components from the one or more generators.

A signal generator (e.g., signal generator 1050, 1040, 1050,3010, 1050A′, 1040A′, 1050M, and/or 1040M) may provide for example two signals (e.g., a modulated signal and an unmodulated signal, two modulated signals, two unmodulated signals) for driving one axis of a scanning device. A modulated signal may include a signal that is amplitude modulated, phase modulated, and/or frequency modulated. A modulated tone may include a tone that is amplitude modulated, phase modulated, and/or frequency modulated. A signal may include a tone.

Alternatively, a signal generator (e.g., signal generator 1050, 1040, 1050, 3010, 1050A′, 1040A′, 1050M, and/or 1040M) may provide for example two tones (e.g., a modulated tone and an unmodulated tone, two modulated tones, two unmodulated tones) for driving one axis of a scanning device. A modulated tone may include a signal (or tone) that is amplitude modulated, phase modulated, and/or frequency modulated.

In an example of including a first modulated signal and a second modulated signal to drive one axis of a scanning device, the first modulated signal may have or have not the same type of modulation as the second modulated signal. For example, a first modulated signal may be amplitude modulated whereas the second modulated signal is not amplitude modulated such as having the second modulated signal being phase modulated and/or frequency modulated.

An optimal (or optimized) scanning pattern may include a fill factor attribute. One or more output signals from processor 1030, 1030A, and/or 1030B provides for the one or more signal generators to output signals which may include multiple signals or multiple tones. Via the processor 1030, 1030A, and/or 1030B each signal of the multiple signals may be set to a predetermined phase angle value for providing at least an optimal scanning pattern (e.g., via a driven scanning device such as MEMS device or other scanning device). For example, a generator may supply or provide two or more signals (or tones) to drive a first axis or second axis of a scanning device. An example of multiple signals includes 2 or more signals. An example of multiple tones includes two or more tones.

A modulated signal may include any of the following: an amplitude modulated signal, a phase modulated signal, a frequency modulated signal, a double sideband suppressed carrier signal, a single sideband signal with carrier signal.

One embodiment may include: An apparatus to provide an optimal scanning pattern within a region of interest comprising: a two dimension scanning device including a first terminal associated with scanning along a first axis and a second terminal associated with scanning along a second axis; combining a first driving signal source and a second driving signal source to provide a first combined signal; coupling the first combined signal to the first terminal of the two dimensional scanning device; coupling a third driving signal source to the second terminal of the scanning device; wherein the first combined signal provides for an optimal scanning pattern within a region of interest.

Another embodiment includes a capacitance measurement system included to an apparatus to provide an optimal scanning pattern (e.g., within a region of interest) comprising: A two dimension scanning device including a first terminal associated with scanning along a first axis and a second terminal associated with scanning along a second axis; combining a first driving signal source and a second driving signal source to provide a first combined signal; coupling the first combined signal to the first terminal of the two dimensional scanning device; coupling a third driving signal source to the second terminal of the scanning device; wherein the first combined signal provides for an optimal scanning pattern within a region of interest.

An embodiment may include driving at least one axis of a scanning device (e.g., 1010 and or CM101) driven with an unmodulated first signal and an unmodulated second signal. The first unmodulated signal includes a first unmodulated signal frequency and a first unmodulated signal amplitude. The second unmodulated signal includes a second unmodulated signal frequency and a second unmodulated signal amplitude. The first unmodulated signal is combined with the second unmodulated signal, wherein the combination of the first unmodulated signal and second unmodulated signal is coupled to a drive input terminal to a 1^{st} axis of the scanning device. The 2^{nd} axis terminal of the scanning device may for example, receive one or more driving signals (e.g., a third unmodulated signal, an unmodulated fourth signal, and/or a modulated signal). In one example, combining the first unmodulated signal with the second unmodulated signal can be characterized as the second unmodulated signal providing an interfering signal to the first unmodulated signal, or vice versa. Having an interfering signal provides a dithering effect. A dithering effect provides increased spatial sampling or spatial resolution in a region of interest (e.g., within a field of view).

For example, the second unmodulated signal provides an interfering effect on the first unmodulated signal, wherein the interfering effect provides a dithering effect on scanning pattern provided by the first unmodulated signal. A dithering effect provides increased spatial sampling or spatial resolution in a region of interest (e.g., within a field of view).

Alternative embodiments of the patent application include having the signal generators 1050, 1040, 1050A′, 1040A′, 3010, and/or 3130 supplying a single frequency signal in certain applications. For example, in some scanning devices (e.g., certain X Y MEMS devices, two dimensional electromechanical devices, or resonant devices), which may be included as devices depicted as 1010 in FIGS. 4, 5, 6, and 15; 3320 in FIG. 8A; or devices depicted as C1 and C2 in FIGS. 8B, C1 and C2, in FIGS. 8C, C1 and C2 in FIG. 8D; and/or CM101 or 1870 in FIG. 17.

In one example a two dimensional resonant scanning device (e.g., a MEMS device or electrostatic device, or capacitive device) may have a first axis whose resonant frequency is changed or shifted by driving the second axis with a sufficient amplitude. The converse may be true in that if the first axis is driven with a sufficient amplitude signal, the resonant frequency associated with the second axis may be changed. Experimentally, in some devices, the resonance frequency associated with a first axis may shift to a lower resonant frequency when a second axis is driven (e.g., with a sufficiently large amplitude), or vice versa. Any of the systems described or illustrated in FIGS. 4, 5, 6, 15, and/or 44 wherein such a 2 dimensional (.e.g., two axis device) resonant scanning device is utilized can be automatically driven to the respective resonant frequencies for associated with the two axis. The systems shown in FIGS. 4, 5, 6, 15, and/or 44 include a feedback system including phase measurement for each axis, a first axis and a second axis. A 1^{st} axis output signal and a 2^{nd} axis output signal are coupled to Hilbert transforms (e.g., 1060 and 1070 in FIG. 5), a phase measurement system (e.g., 1160 and 1170 in FIG. 6), or a processor including phase measurement apparatus (e.g., 1030 in FIG. 4 and/or FIGS. 17, or 1030M0 in FIG. 15). The phase relationship is measured related to the 1^{st} and 2^{nd} axis, which results in a signal sent via the processor 1030 or 1030M0 to a first and second signal generator, adjusts the frequencies for the first and second axes to the resonant frequency. For example, at resonance of the first and second axis portion of the scanning device, an electrostatic device will generally provide a 90 degrees (e.g., normalized) phase shift with respect to the (e.g., input) driving signal (e.g., signal supplied to the 1^{st} axis drive input terminal and signal supplied to the 2^{nd} axis drive input terminal, or drive signals via SigGenOut1 and/or SigGenOut2 from 1050″ and/or 1040″) and the 1^{st} axis output signal and/or the 2^{nd} axis output signal. For example, because many electrostatic scanning devices can be modeled as a two pole medium to high Q (Q = Quality Factor) low pass filter whereby at the resonant frequency is 90 degrees, a 1^{st} axis drive signal from a 1^{st} axis drive signal generator is adjusted for frequency via a control signal (e.g., via a processor such as 1030, 1030A, 1030B, or 1030M0: or from a phase lock loop circuit; or a phase comparator and/or amplifier circuit) to the 1^{st} axis drive signal generator such that there is a nominally 90 degree phase relationship between the 1^{st} axis drive signal and the 1^{st} axis output signal (or DM1o, a demodulated first axis output signal in FIG. 17). Similarly, a 2^{nd} axis drive signal from a 2^{nd} axis drive signal generator is adjusted for frequency via a control signal (e.g., via a processor such as 1030, 1030A, 1030B, or 1030M0: or from a phase lock loop circuit) to the 2^{nd} axis drive signal generator such that there is a nominally 90 degree phase relationship between the 2^{nd} axis drive signal and the 2^{nd} axis output signal (or DM2o, a demodulated second axis output signal in FIG. 17).

It should be noted that a 1^{st} axis drive signal generator and/or a 2^{nd} axis drive signal generator may output an unmodulated signal or a modulated signal. A modulated signal such as an amplitude modulated signal would be coupled to a phase measurement system, which operates on zero crossings of the amplitude modulated signal while providing at least sufficiently accurate measurement of the phase of the amplitude modulated signal (e.g., accurate measurement of a carrier signal included in the amplitude modulated signal).

A scanning device such as 1010 may include CM101 (e.g., an electrostatic device or capacitive device) in FIG. 17 in another embodiment. In FIG. 17, one or more blocks A1, 1910, 1920, 1930, and/or 1940 may form or provide a position to signal converter similar to 1020.

It is recognized and appreciated that as specific examples, the above-characterized figures and discussion are provided to help illustrate certain aspects (and advantages in some instances) which may be used in the manufacture of such structures and devices. These structures and devices include the exemplary structures and devices described in connection with each of the figures as well as other devices, as each such described embodiment has one or more related aspects which may be modified and/or combined with the other such devices and examples as described hereinabove may also be found in the above-referenced Provisional Application.

The skilled artisan would also recognize various terminology as used in the present disclosure by way of their plain meaning. As examples, the Specification may describe and/or illustrates aspects useful for implementing the examples by way of various semiconductor materials, circuits and/or optics elements which may be illustrated as or using terms such as layers, blocks, modules, device, system, unit, controller, and/or other related depictions. Such circuitry, optics and/or semiconductive materials (including portions of semiconductor structure) and circuit elements may be used together with other aspects to exemplify how certain examples may be carried out in the form or structures, steps, functions, operations, activities, etc.

It will also be apparent that aspects of the various example embodiments may include a controller implemented as or including a computer processing circuit that is configured to operate consistent with the operation(s) of the embodiment, such as control circuitry configured to generate, alter and/or control the scanning output. In certain embodiments, such circuits can correspond to one or more computer processing circuits programmed to execute a set (or sets) of instructions (and/or configuration data). The instructions (and/or configuration data) can be in the form of software stored in and accessible from a memory circuit, and where such circuits are directly associated with one or more algorithms (or processes), the activities pertaining to such algorithms are not necessarily limited to the specific flows such as shown in the flow charts illustrated in the figures (e.g., where a circuit is programmed to perform the related steps, functions, operations, activities, etc., the flow charts are merely specific detailed examples). The skilled artisan would also appreciate that different (e.g., first and second) modules can include a combination of a central processing unit (CPU) hardware-based circuitry and a set of computer-executable instructions, in which the first module includes a first CPU hardware circuit with one set of instructions and the second module includes a second CPU hardware circuit with another set of instructions.

It would also be appreciated that terms to exemplify orientation, such as upper/lower, left/right, top/bottom and above/below, may be used herein to refer to relative positions of elements as shown in the figures. It should be understood that the terminology is used for notational convenience only and that in actual use the disclosed structures may be oriented different from the orientation shown in the figures. Thus, the terms should not be construed in a limiting manner.

Based upon the above discussion and illustrations, those skilled in the art will readily recognize that various modifications and changes may be made to the various embodiments without strictly following the exemplary embodiments and applications illustrated and described herein. For example, methods as exemplified in the Figures may involve steps carried out in various orders, with one or more aspects of the embodiments herein retained, or may involve fewer or more steps. Such modifications do not depart from the true spirit and scope of various aspects of the disclosure, including aspects set forth in the claims.

What is claimed:

1. A method comprising:
adaptively scanning a target area, by use of a scanning output controlled by a multiple-axis scanner, within a selected region of interest (RoI) in a field of view (FoV) as a function of a first drive signal having a first set of one or more frequency components and of a second drive signal having a second set of one or more frequency components;
modulating one or more aspects of at least the first drive signal to produce a plurality of drive signals including the modulated first drive signal; and
using the plurality of drive signals at the multiple-axis scanner to control the scanning output, to cause the scanning output to traverse the selected RoI more times than other portions of the FoV and spatially sample the target area via a higher concentrations of samples in the RoI.

2. The method of claim 1, wherein the multiple-axis scanner is driven to follow an optimized scanning trajectory, set as a function of a scanning-pattern optimization process, and to produce a corresponding sampling pattern.

3. The method of claim 1, further including generating a set of RoI-estimation data as a function of depth and intensity information uniformly detected across the FoV, wherein the selected RoI is processed as a function of the set of RoI-estimation data.

4. The method of claim 1, wherein modulating one or more aspects of at least the first drive signal includes altering one or more signal characteristics of the first drive signal in terms of one or more of: frequency, amplitude and phase.

5. The method of claim 1, wherein modulating one or more aspects of at least the first drive signal includes modulating one or more characteristics of each of the first drive signal and the second drive signal, wherein said one or more characteristics includes one or more of: frequency, amplitude and phase.

6. The method of claim 1, wherein modulating one or more aspects of at least the first drive signal includes producing the plurality of drive signals including the modulated first drive signal, at terminals coupled to or integrated with multiple-axis scanner, wherein the terminals correspond to one or more of: axis-drive terminals, signal-output terminals, and one or more power-common terminals.

7. The method of claim 1, further including generating data corresponding to the selected RoI as one of multiple regions in the FoV, wherein the generated data corresponding to the selected RoI corresponds to prioritized or more heavily weighted one of the multiple regions in the FoV.

8. The method of claim 1, further including using multiple laser-scanners, wherein the multiple-axis scanner is one of among multiple laser-scanners which are cooperatively configured and used to adaptively scan the RoI according to an optimized scanning trajectory which is divided into multiple sections, and wherein each scanner is actuated individually and follows one trajectory section.

9. The method of claim 1, wherein the first drive signal includes or corresponds to a set of multi-frequency signals.

10. The method of claim 1, wherein the first drive signal includes a first set of multi-frequency signals corresponding to a first tone, and the second drive signal includes a second set of multi-frequency signals corresponding to a different second tone.

11. The method of claim 10, wherein said modulating includes or involves at least one of the following: phase shifting at least one frequency of the first drive signal; and phase shifting at least one frequency of the second drive signal.

12. The method of claim 1, further including using a capacitance-type sensing system, wherein the scanning output is directed by a MEMS mirror device capable of moving in two or more directions.

13. The method of claim 1, further including using a capacitance-type sensing system to generate a first axis output signal and a second axis output signal according to a scanning pattern in the RoI, with the RoI being characterized as a function of a first axis and a second axis, wherein the capacitance-type sensing system scans the RoI using a scanning motion, via a first high frequency signal related to the first axis and using a second frequency signal related to the second axis.

14. The method of claim 1, further including using a capacitance-type sensing system to generate a first axis output signal and a second axis output signal according to a scanning pattern in the RoI, by providing a change to the one or more aspects of at least the first drive signal in terms of at least one of: amplitude and phase.

15. The method of claim 1, further including:
generating the scanning output via a multi-dimensional scanner,
combining the first drive signal and the second drive signal and, in response, providing a first combined signal that is coupled to a first terminal of the multi-dimensional scanner; and
coupling a third drive signal to a second terminal of the multi-dimensional scanner and, in response, using the first combined signal and the third drive signal to provide an optimal scanning pattern within a region of interest.

16. The method of claim 1, wherein the scanning output includes one of: piezo-electrical signal, a light beam, and a magnetic signal.

17. An apparatus comprising:
a multiple-axis scanner to adaptively scan a target area by use of a scanning output, and to control the scanning output within a selected region of interest (ROI) in a field of view (FoV), as a function of a first drive signal having a first set of one or more frequency components and of a second drive signal having a second set of one or more frequency components; and
signal processing circuitry to
modulate one or more aspects of at least the first drive signal and, in response, to produce a plurality of drive signals including the modulated first drive signal, and
use the plurality of drive signals at the multiple-axis scanner to control the scanning output, and therein cause the scanning output to traverse the selected RoI more times than other portions of the FoV and spatially sample the target area via a higher concentrations of samples in the RoI.

18. An apparatus to provide an optimal scanning pattern within a region of interest, the apparatus comprising:
a multi-dimensional scanner including a first terminal associated with scanning along a first axis and a second terminal associated with scanning along a second axis; and
signal processing circuitry, integrated or coupled to the multi-dimensional scanner, to
combine a first drive signal and a second drive signal and, in response, to provide a first combined signal that is coupled to the first terminal of the multi-dimensional scanner; and
couple a third drive signal to the second terminal of the multi-dimensional scanner, wherein the first combined signal provides for an optimal scanning pattern within a region of interest.

19. The apparatus claim 18, wherein the first drive signal includes a first modulated signal and the second drive signal includes a second modulated signal, and wherein each of the first modulated signal includes one or more of: amplitude modulation, phase modulation, and frequency modulation, and the second modulated signal includes one or more of: amplitude modulation, phase modulation, and frequency modulation.

20. A storage device including instructions which, in response to being accessed computer circuitry, causes a method to be performed, the method comprising:
adaptively scanning a target area, by use of a scanning output controlled by a multiple-axis scanner, within a selected region of interest (RoI) in a field of view (FoV) as a function of a first drive signal having a first set of one or more frequency components and of a second drive signal having a second set of one or more frequency components;
modulating one or more aspects of at least the first drive signal to produce a plurality of drive signals including the modulated first drive signal; and
using the plurality of drive signals at the multiple-axis scanner to control the scanning output, to cause the scanning output to traverse the selected RoI more times than other portions of the FoV and spatially sample the target area via a higher concentrations of samples in the RoI.
